(19) United States
(12) Patent Application Publication
(10) Pub. No.: US 2009/0132344 A1
(43) Pub. Date: May 21, 2009

(54) System and method for scanning a coupon to initiate an order

(75) Inventors: Jonathan Otto, Palm Beach, FL (US); Andrew Van Luchene, Santa Fe, NM (US); Raymond J. Mueller, Palm Beach Gardens, FL (US); Michael R. Mueller, San Francisco, CA (US)

Correspondence Address: SIMPSON & SIMPSON, PLLC, 5555 MAIN STREET, WILLIAMSVILLE, NY, 14221-5406, US

(73) Assignee: RetailDNA, LLC, West Palm Beach, FL (US)

(21) Appl. No.: 12/217,821

(22) Filed: Jul. 9, 2008

Related U.S. Application Data
(63) Continuation-in-part of application No. 12/151,038, filed on May 2, 2008.
Application No. 12/151,038 is a continuation-in-part of application No. 11/983,679, filed on Nov. 9, 2007.
Application No. 11/983,679 is a continuation-in-part of application No. 09/993,228, filed on Nov. 14, 2001.

(51) Int. Cl. G06Q 30/00; G06F 19/00; G06Q 20/00; G07F 19/00

(52) U.S. Cl. 705/10; 235/375; 705/14; 705/21

(57) ABSTRACT

A system for initiating an order by scanning a coupon, including: a processor for at least one specially programmed general-purpose computer; an interface element for the at least one specially programmed general-purpose computer; and, an offer element, in the processor for: generating barcode data including information regarding items or services included in a fulfilled order; transmitting, using an interface element, the barcode data for output at a first point of sale (POS) device; receiving, using the interface element, the barcode data inputted via a second POS device; generating, in response to the inputted barcode data, a order offer including at least one item or service included in the fulfilled order; and transmitting, using the interface element, the order offer for output via the second POS device. A method for initiating an order by scanning a coupon

### CROSS-REFERENCE TO RELATED APPLICATIONS

This is a continuation-in-part patent application under 35 USC 120 of U.S. patent application Ser. No. 12/151,038, filed May 2, 2008 and entitled “Method and Apparatus for Generating and Transmitting an Order Initiation Offer to a Wireless Communications Device” and of U.S. patent application Ser. No. 12/151,043, filed May 2, 2008 and entitled “Method and System For Centralized Generation of a Business Executable Using Genetic Algorithms and Rules Distributed Among Multiple Hardware Devices,” which is a continuation-in-part of U.S. patent application Ser. No. 11/983,679, filed Nov. 9, 2007 and entitled “Method and System for Generating, Selecting, and Running Executables in a Business System Utilizing a Combination of User Defined Rules and Artificial Intelligence” which is a continuation-in-part patent application under 35 USC 120 of U.S. patent application Ser. No. 09/993,228, filed Nov. 14, 2001 and entitled “Method and apparatus for dynamic rule and/or offer generation,” which applications are incorporated herein by reference.

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to a method and system for initiating an order by scanning a coupon.

### BACKGROUND OF THE INVENTION

It would be desirable to enable initiation and presentation of an order minimizing effort required by a customer and an entity receiving the order.

Thus, there is a long-felt need to provide a system and a method to intelligently and automatically initiate an order operation with minimal expenditure.

### SUMMARY OF THE INVENTION

The invention broadly comprises a system for initiating an order by scanning a coupon, including: a processor for at least one specially programmed general-purpose computer; an interface element for the at least one specially programmed general-purpose computer; and, an offer element, in the processor for: generating barcode data including information regarding items or services included in a fulfilled order; transmitting, using an interface element, the barcode data for output at a first point of sale (POS) device; receiving, using the interface element, the barcode data inputted via a second POS device; generating, in response to the inputted barcode data, a order offer including at least one item or service included in the fulfilled order; and transmitting, using the interface element, the order offer for output via the second POS device.

In one embodiment, the offer element is for: using at least one of a set of rules or an artificial intelligence program stored in a memory unit for the at least one specially programmed general-purpose computer to selecting at least one item or service not included in the fulfilled order or at least one incentive not included in the fulfilled order; and, including, in the order offer, the at least one item or service not included in the fulfilled order or the at least one incentive not included in the fulfilled order. In another embodiment, the barcode data includes information regarding order payment authorization and the offer element is for executing payment for an order placed in response to the order offer using the order payment authorization and the barcode data includes the order payment authorization, or the order payment authorization is stored in a memory unit for the at least one specially programmed general-purpose computer and the barcode data includes information for accessing the order payment authorization in the memory unit.

In a further embodiment, the offer element is for generating the order offer only if a first condition is satisfied, the first condition selected from the group consisting of a specified time after the barcode data is transmitted, a specific date, a specific time of day, a specific day of the week or month, or a date having a specified relationship with one or more other dates; or transmitting the order offer only if a second condition is satisfied, the second condition selected from the group consisting of a specified time after the barcode data is transmitted, a specific date, a specific time of day, a specific day of the week or month, or a date having a specified relationship with one or more other dates. In one embodiment, the offer element is for selecting the first condition using at least one of a first set of rules or a first artificial intelligence program stored in a memory unit for the at least one specially programmed general-purpose computer; or selecting the second condition using at least one of a second set of rules or a second artificial intelligence program stored in a memory unit for the at least one specially programmed general-purpose computer.

In one embodiment, the offer element is for: receiving at a first time, using the interface element, the order for fulfillment from a wireless communications device (WCD) via a wireless communications network; storing the fulfilled order in a memory unit for the at least one specially programmed general-purpose computer; receiving at a second time after the first time, using the interface element, an input from the WCD via a wireless communications network; and generating, in response to receiving the input from the WCD, the order offer to include an item or service included in the fulfilled order. In another embodiment, the offer element is for selecting, using at least one of a set of rules or an artificial intelligence program stored in the memory unit, an item or service not included in the order for fulfillment; and, including, in the order offer, the item or service not included in the order for fulfillment.

In a further embodiment, the offer element is for: receiving at a first time, using the interface element, the order for fulfillment; storing, using the processor, a customer identification associated with the order for fulfillment in a memory unit for the at least one specially programmed general-purpose computer; storing the order for fulfillment in the memory unit; receiving at a second time after the first time, using the interface element, an input; matching, using the interface element, the customer identification with the input; and generating, in response to matching the input, the order offer to include an item or service included in the order for fulfillment. In one embodiment, the offer element is for selecting, using at least one of a set of rules or an artificial intelligence program stored in the memory unit, an item or service not included in the order for fulfillment; and, including, in the order offer, the item or service not included in the order for fulfillment.

The invention broadly comprises a system for initiating an order by scanning a coupon, including: a processor for at least one specially programmed general-purpose computer; a memory element for the at least one specially programmed general-purpose computer; an interface element for the at least one specially programmed general-purpose computer; and an offer element, in the processor for: receiving, at a first time and using the interface element, an order from a first point of sale (POS) device or from a first wireless communications device (WCD), the first order including: at least one item or service; and an identification for the WCD; or a customer identification associated with the order; storing the order, identification for the WCD, and the customer identification in the memory unit; receiving, at a second time different than the first time and using the interface element, an input from a second WCD or a second POS device; matching, using the processor, the WCD identification or the customer identification with the transmission or the input, respectively; generating an order offer including at least one item or service included in the order; and transmitting, using the interface element, the offer for output at the WCD or for output at the second POS device.

In one embodiment, the offer element is for: using at least one of a set of rules or an artificial intelligence program stored in the memory unit to select at least one item or service not included in the order or at least one incentive not included in the order; and, including, in the offer, the at least one item or service not included in the order or the at least one incentive not included in the order.

The invention also broadly comprises a method for initiating an order by scanning a coupon.

It is a general object of the present invention to provide a system and a method to intelligently and automatically initiate an order operation with minimal expenditure.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic block diagram of a present invention apparatus for generating and transmitting an order initiation offer to a wireless communications device (WCD);

FIG. 2 is a flow chart of a present invention method for generating and transmitting an order initiation offer to a wireless communications device (WCD);

FIG. 3 is a schematic block diagram of a present invention system for initiating an order by scanning a coupon;

FIG. 4 is a schematic block diagram of a present invention system for initiating an order by scanning a coupon;

FIG. 5 is a flow chart of a present invention method for initiating an order by scanning a coupon; and,

FIG. 6 is a flow chart of a present invention method for initiating an order by scanning a coupon.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

It should be understood that the use of “or” in the present application is with respect to a “non-exclusive” arrangement, unless stated otherwise. For example, when saying that “item x is A or B,” it is understood that this can mean one of the following: 1) item x is only one or the other of A and B; and 2) item x is both A and B. Alternately stated, the word “or” is not used to define an “exclusive or” arrangement. For example, an “exclusive or” arrangement for the statement “item x is A or B” would require that x can be only one of A and B.

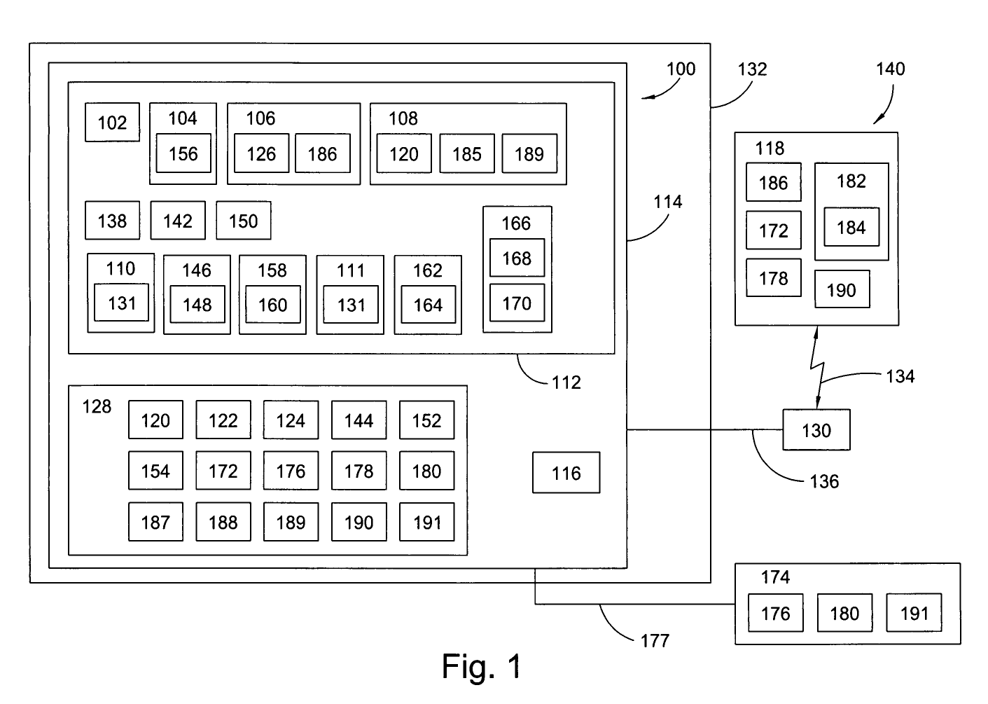

FIG. 1 is a block diagram for present invention system 100 for generating and transmitting an order initiation offer to a wireless communications device (WCD). System 100 includes: identification element 102, eligibility element 104, executable element 106, offer element 108, transceiver element 110, and order initiation element 111, all located in processor 112 of at least one specially programmed general-purpose computer 114. Alternately stated, elements 102, 104, 106, 108, 110, and 111, and any other elements described as being in the processor are functions of the processor or are functions carried out by the processor.

Element 102 identifies, using interface element 116, WCD 118. The eligibility element determines if the WCD is eligible to receive order initiation offer 120. Offer 120 is an offer that is made that when accepted (further described below) initiates a transaction. The executable element is arranged to generate, using one or both of rules 122 and artificial intelligence program 124, at least one executable 126. The set of rules and the artificial intelligence program are stored in memory unit 128. In one embodiment, the executable is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 114 receives at least one modifying rule 172 from a WCD and stores the rule in memory 128. In another embodiment, the WCD is WCD 118. The executable element modifies executable 126 using rule 172. The WCD generates rule 172, and the executable element modifies executable 126 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 174, separate from computer 114, transmits modifying rule 176 to computer 114. Computer 174 can be in location 132 (not shown) or can be in a different location. Computer 174 can be associated with a business entity associated with location 132 or can be associated with a different business entity. Connection 177 between computers 114 and 342 is any type known in the art. In another embodiment (not shown), multiple computers 174 are included and respective computers among the multiple computers can be associated with the same or different business entities. Computer 114 stores modifying rule 176 in memory 128. Element 106 modifies executable 126 using rule 176. Computer 174 generates rule 176, and element 106 modifies executable 126, respectively, as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

The executable is directed toward determining an offer that is most acceptable to an end user of the WCD and best meets prescribed criteria of the entity making the offer. For example, acceptability could be based on price, free items, or other criteria mentioned below. Rules 122 or program 124 are used to find the appropriate combination of acceptability and entity criteria.

The offer element generates, for an eligible WCD and using the at least one executable, an appropriate order initiation offer 120. In general, the core of offer 120 is shaped by, determined by, or consists of executable 126. The transceiver element transmits, using the interface element, the appropriate order initiation offer 120 to wireless communications network 130 for transmission to the WCD. The transceiver element also is arranged to receive, via the interface element, response 131, including an order, from the WCD. Element 111 initiates fulfillment of the order by any means known in the art.

By interface element, we mean any combination of hardware, firmware, or software in a computer used to enable communication or data transfer between the computer and a device, system, or network external to the computer. The interface element can connect with the device, system, or network external to the computer, for example, network 130, using any means known in the art, including, but not limited to a hardwire connection, an optical connection, an Internet connection, or a radio frequency connection. Processor 112 and interface element 116 can be any processor or interface element, respectively, or combination thereof, known in the art.

Computer 114 can be any computer or plurality of computers known in the art. In one embodiment, the computer is located in a retail location with which system 100 is associated, for example, location 132. In another embodiment (not shown), all or parts of the computer are remote from retail locations with which system 100 is associated. In a further embodiment, computer 114 is associated with a plurality of retail locations with which system 100 is associated. Thus, the computer provides the functionality described for more than one retail location. In one embodiment, offer 120 is for an item, good, or service provided by the entity associate with location 132.

A WCD is defined supra. WCD 118 can be any WCD known in the art. In one embodiment, WCD 118 is owned by, leased by, or otherwise already in possession of the end user when system 100 interfaces with the WCD. In the description that follows, it is assumed that the WCD is owned by, leased by, or otherwise already in possession of the end user when system 100 interfaces with the WCD. In general, the WCD communicates with a network, for example, network 130, via radio-frequency connection 134. Network 130 can be any network known in the art. In one embodiment, the network is located outside of the retail location, for example, the network is a commercial cellular telephone network. In one embodiment (not shown), the network is located in a retail location, for example, the network is a local network, such as a Bluetooth network. The interface element can connect with network 130 using any means known in the art, including, but not limited to a hardwire connection, an optical connection, an Internet connection, or a radio frequency connection. In the figures, a non-limiting example of a hardwire connection 136 is shown. In one embodiment, device 118 is connectable to a docking station (not shown) to further enable communication between device 118 and system 100. Any docking station or docking means known in the art can be used. That is, when the device is connected to the docking station, a link is established between the device and system 100.

In a first embodiment, system 100 includes location element 138 in the processor, which determines, using the interface element, location 140 for the WCD. The location of the WCD can be determined using any means known in the art, including, but not limited to, GPS technology and information from network 130. Then, the eligibility element determines eligibility in response to location 140, the executable element generates the at least one executable responsive to location 140, or the offer element generates an appropriate order initiation offer responsive to location 140. It should be understood that any combination of the eligibility, executable, and offer elements can operate responsive to location 140. Any criteria known in the art can be used to control the operation of the eligibility, executable, and offer elements responsive to location 140. For example, the elements can operate when the WCD is within a certain specified distance from one or more retail locations, for example, location 132; the elements can operate to generate offer 120 for a specific retail location according to location 140; or the elements can operate to generate offer 120 offering options with respect to a plurality of retail locations (not shown) based on respective distances of the WCD from the plurality of locations.

In a second embodiment, system 100 includes transaction element 142 that accesses transaction history 144, stored in the memory unit, for the WCD or an end user (not shown) associated with the WCD. In one embodiment, the history is stored in a separate computer system (not shown) accessed by system 100. The eligibility element determines eligibility in response to history 144, the executable element generates the at least one executable responsive to history 144, or the offer element generates an appropriate order initiation offer responsive to history 144. It should be understood that any combination of the eligibility, executable, and offer elements can operate responsive to history 144.

Any criteria known in the art can be used to control the operation of the eligibility, executable, and offer elements responsive to history 144. For example, executable 126 can be generated in response to trends noted in the history. The executable can be directed to a continuation of the trend or can derive variants from the trend that may be acceptable to the end user and in the interest of the retail location. Further, the continuation or variants can be aligned with parameters defined for the retail location. For example, the executable can be addressed to a desired promotion, conditions at the retail location, such as stock on hand, or attempts to increase a total bill for the end user.

In another embodiment, history 144 includes searches made using the WCD or communications by the WCD. Alternately stated, system 100 is linked to search browsers associated with the WCD. Any type of search or WCD communication known in the art can be included in history 144. For example, if the WCD has been used to search for products typically available at a retail location similar to location 132, the offer element generates offers for transmission to the WCD when the WCD is within a specified location of such a retail location, for example, location 132. As another example, the communications can be, but are not limited to, telephone calls or email messages to a specific retail location or to a category of retail locations. As another example, if history 144 shows that the WCD has communicated with location 132, then eligibility or the offer can be tailored in response to this information.

In a third embodiment, the eligibility element determines eligibility in response to a time of day, in general, the time of day when the WCD is identified, the executable element generates the at least one executable responsive to the time of day, or the offer element generates an appropriate order initiation offer responsive to the time of day. It should be understood that any combination of the eligibility, executable, and offer elements can operate responsive to the time of day. Any criteria known in the art can be used to control the operation of the eligibility, executable, and offer elements responsive to the time of day. For example, executable 126 can be generated in response to trends for an end user with respect to the time of day or with parameters for the retail location associated with the time of day. The executable can be directed to a continuation of the trend or can derive variants from the trend that may be acceptable to the end user. Further, the continuation or variants can be aligned with parameters defined for the retail location. For example, the executable can be addressed to a desired promotion, conditions at the retail location, such as stock on hand, or attempts to increase a total bill for the end user.

In a fourth embodiment, the eligibility element determines eligibility in response to the day of the week, the executable element generates the at least one executable responsive to the day of the week, or wherein the offer element generates an appropriate order initiation offer responsive to the day of the week. It should be understood that any combination of the eligibility, executable, and offer elements can operate responsive to the day of the week. Any criteria known in the art can be used to control the operation of the eligibility, executable, and offer elements responsive to the day of the week. For example, executable 126 can be generated in response to trends for an end user with respect to the day of the week or with parameters for the retail location associated with the day. In general, this embodiment operates similar to the embodiment directed to the time of day.

In a fifth embodiment, system 100 includes volume element 146, in the processor, which determines transaction volume 148 for at least one retail location, for example, location 132. Element 146 can use any means known in the art to determine volume 148. In one embodiment, element 146 interfaces with another computer system (not shown) associated with location 132 to determine or obtain volume 148. The eligibility element determines eligibility in response to volume 148, the executable element generates the at least one executable responsive to volume 148, or the offer element generates an appropriate order initiation offer responsive to volume 148. It should be understood that any combination of the eligibility, executable, and offer elements can operate responsive to volume 148. Any criteria known in the art can be used to control the operation of the eligibility, executable, and offer elements responsive to volume 148. For example, executable 126 can be generated to create offers that are higher profit (may be less acceptable to an end user) if the volume is high or can generate lower profit (more acceptable offers) if the volume is low. Also, executable 126 can be refined to address respective volume data for various products or groups of products, rather than overall volume.

In a sixth embodiment, system 100 includes order element 150, in the processor, which determine whether an order (not shown) has been placed previously using the WCD. In one embodiment, element 150 interfaces with another computer system (not shown) associated with location 132 to determine or obtain information regarding a previous order. Then, the eligibility element determines eligibility in response to whether an order has been placed previously using the WCD, the executable element generates the at least one executable responsive to whether an order has been placed previously using the WCD, or the offer element generates an appropriate order initiation offer responsive to whether an order has been placed previously using the WCD. It should be understood that any combination of the eligibility, executable, and offer elements can operate responsive to whether an order has been placed previously using the WCD. Any criteria known in the art can be used to control the operation of the eligibility, executable, and offer elements responsive to whether an order has been placed previously using the WCD. For example, executable 126 can be generated to present more acceptable (perhaps lower profit) offers to first time orders from the WCD or can present more acceptable offers to reward continued use of the WCD to place orders.

In a seventh embodiment, element 150 determines whether an order has been placed previously using the WCD during a specified time of day or a specified day of the week. Then, the eligibility element determines eligibility in response to whether an order has been placed previously using the WCD during a specified time of day or a specified day of the week, the executable element generates the at least one executable responsive to whether an order has been placed previously using the WCD during a specified time of day or a specified day of the week, or the offer element generates an appropriate order initiation offer responsive to whether an order has been placed previously using the WCD during a specified time of day or a specified day of the week. It should be understood that any combination of the eligibility, executable, and offer elements can operate responsive to whether an order has been placed previously using the WCD during a specified time of day or a specified day of the week. Any criteria known in the art can be used to control the operation of the eligibility, executable, and offer elements responsive to whether an order has been placed previously using the WCD during a specified time of day or a specified day of the week. This embodiment is a refinement of the previous embodiment. For example, additional temporal criteria are added to the generation of the executable.

In an eighth embodiment, the eligibility element generates, using at least one of set of rules 152 and artificial intelligence program 154, at least one executable 156. Set of rules 152 and artificial intelligence program 154 are stored in the memory unit. The eligibility element is arranged to determine if the WCD is eligible to receive an order initiation using executable 156. In one embodiment, executable 156 is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 114 receives at least one modifying rule 178 from a WCD and stores the rule in memory 128. In another embodiment, the WCD is WCD 118. Element 104 modifies executable 156 using rule 178. The WCD generates rule 178 and element 104 modifies executable 156 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 174 transmits at least one modifying rule 180 to computer 114. Computer 114 stores modifying rule 180 in memory 128. Element 104 modifies executable 156, using rule 180. Computer 174 generates rule 180, and element 104 modifies executable 156, respectively, as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, the eligibility element determines if an end user associated with the WCD is eligible for the order initiation offer. That is, the criteria with respect to eligibility are with respect to an end user of the WCD. In another embodiment, system 100 includes receiving element 158, in the processor, arranged to receive, using the interface element, transmission 160 from the WCD via the communication network. The identification element identifies the WCD in response to the transmission, using any means known in the art. That is, rather than system 100 contacting the WCD to initiate the operations noted above, system 100 initiates the operations after being contacted by the WCD.

In a further embodiment, system 100 includes inventory element 162, in the processor, which obtains inventory information 164. In general, information 164 related to inventory availability, for example, an inventory of product or services in stock or ready for purchase at the retail location. For example, in a restaurant, information 164 might be regarding the number and type of already-prepared breakfast items at the restaurant. In a location selling durable goods, such as appliances, the information could be regarding whether various of the durable goods are in stock at the retail location. In yet another embodiment, element 162 interfaces with another system, for example, a local or centralized computer system associated with operations at the retail location, to obtain information 164, or to obtain data to determine information 164. In a still further embodiment, element 162 compiles the data necessary to determine information 164. For example, operations at the retail location are processed by computer 114. The eligibility element determines eligibility in response to inventory information, for example, if there is a surplus of items on hand, the requirements for eligibility can be loosened, the executable element generates the at least one executable responsive to inventory information, or the offer element generates an appropriate order initiation offer responsive to inventory information, for example, if the supply of items on hand is low, offers for that item can be made more profitable for the retail location.

In one embodiment, system 100 includes registration element 166, in the processor, which communicates with the WCD through the transceiver element. Element 166 transmits information 168 regarding registration of a WCD with system 100, for example, soliciting registration, providing instructions for registering, and promoting registration. Element 166 also receives registration information 170 for the WCD.

In one embodiment, memory element 182 in WCD 118 stores at least one rule 184. Processor 186 in the WCD implements offer 120 according to rule 184. The WCD generates rule 184, and operates on offer 120 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment the offer element determines redemption rate 185 for offer 126. The executable element generates at least one executable 186, using the redemption rate, and at least one of set of rules 187 or artificial intelligence program 188 stored in memory unit 128. The offer element generates appropriate order initiation offer 189 using executable 186, and the transmission element transmits, using the interface element, offer 189 to the wireless communications network for transmission to the WCD.

In another embodiment, the offer element modifies, using the redemption rate, rules 122 or artificial intelligence program 124 to create rules 187 or artificial intelligence program 188, respectively.

In a further embodiment, offers 120 and 189 are transmitted to the WCD regardless of the location of the WCD with respect to a business location, for example, location 132, and stored in memory 182. The location element determines, using the interface element, when the WCD is within a specified distance (not shown) of the business location and retrieves, using the interface element, offer 120 or 189 from memory 182 for presentation, for example, on a point of sale station for the business location. In another embodiment, offers 120 and 189 are stored in memory 128 until the location element, using the interface element, identifies the WCD as being within a specified distance (not shown) of the business location, at which time offers 120 and 189 are transmitted to the WCD.

In one embodiment, computer 114 receives at least one modifying rule 190 from a WCD and stores the rule in memory 128. In another embodiment, the WCD is WCD 118. Element 106 modifies executable 186 using rule 190. The WCD generates rule 190 and element 106 modifies executable 186 as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 174 transmits at least one modifying rule 191 to computer 114. Computer 114 stores modifying rule 191 in memory 128. Element 106 modifies executable 186, using rule 191. Computer 174 generates rule 191, and element 106 modifies executable 186, respectively, as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

It should be understood that various storage and removal operations, not explicitly described above, involving memory 128 and as known in the art, are possible with respect to the operation of system 100. For example, outputs from and inputs to the general-purpose computer can be stored and retrieved from the memory elements and data generated by the processor can be stored in and retrieved from the memory.

It should be understood that the locating element can determine the distance of the WCD from more than one business, or retail, location. It also should be understood that the offer element can generate and transmit more than one offer for a business location and can generate respective offers for more than one business location or entity. It also should be understood that a plurality of distance and offer criteria and metrics can be used by the location and offer elements to determine a distance to use and to generate an offer, respectively. The criteria and metrics can include, but are not limited to, information specific to operations at a particular business entity or business location, geographical information, and temporal aspects, such as time of day.

It should be understood that system 100 can be operated by the same business entity operating or owning a business location using the system, or can be operated by a third party different than the business entity operating or owning the business location using the system. In one embodiment, a third party operates system 100 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

It should be understood that system 100 can be integral with a computer operating system for a business location, for example, location 132 or with a business entity operating the business location. It also should be understood that system 100 can be wholly or partly separate from the computer operating system for a retail location, for example, location 132, or with a business entity operating the business location.

It should be understood that although individual rule sets and artificial intelligence programs are discussed, the individual rule sets and AI programs can be combined into composite rules sets or artificial intelligence programs. Any combination of individual rule sets or artificial intelligence programs is included in the spirit and scope of the claimed invention. For example, rules 122 and 152 can be a single set of rules (not shown) or artificial intelligence programs 124 and 154 can be a single program (not shown).

It should be understood that the examples above regarding executables are non-limiting, are meant to provide only a broad overview, and do not address the number, complexity, structure, or interrelationships of the operations included in the actual generation of the executables.

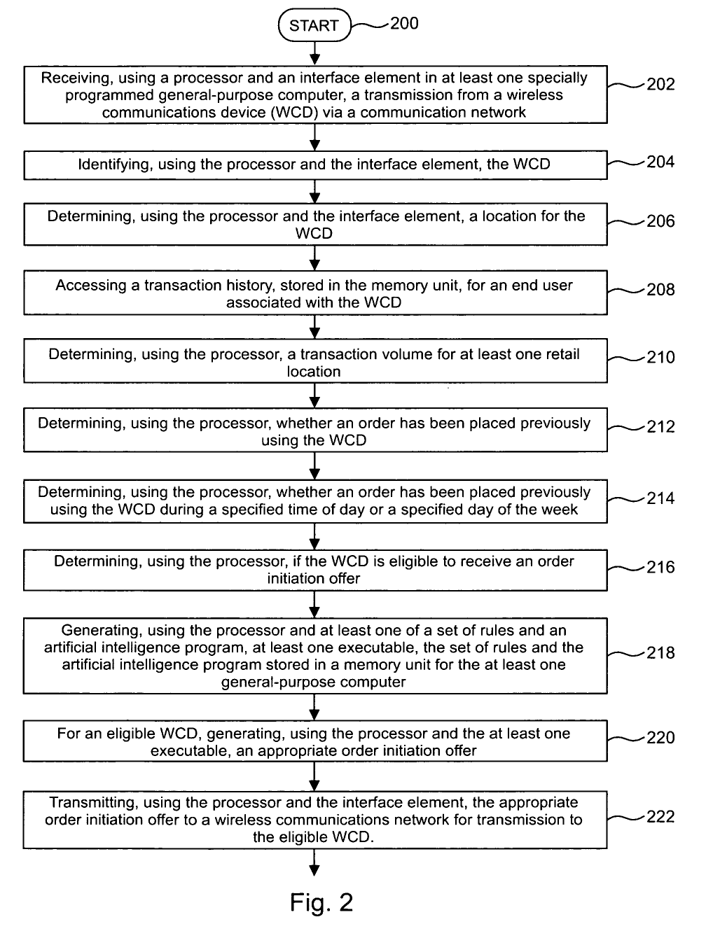

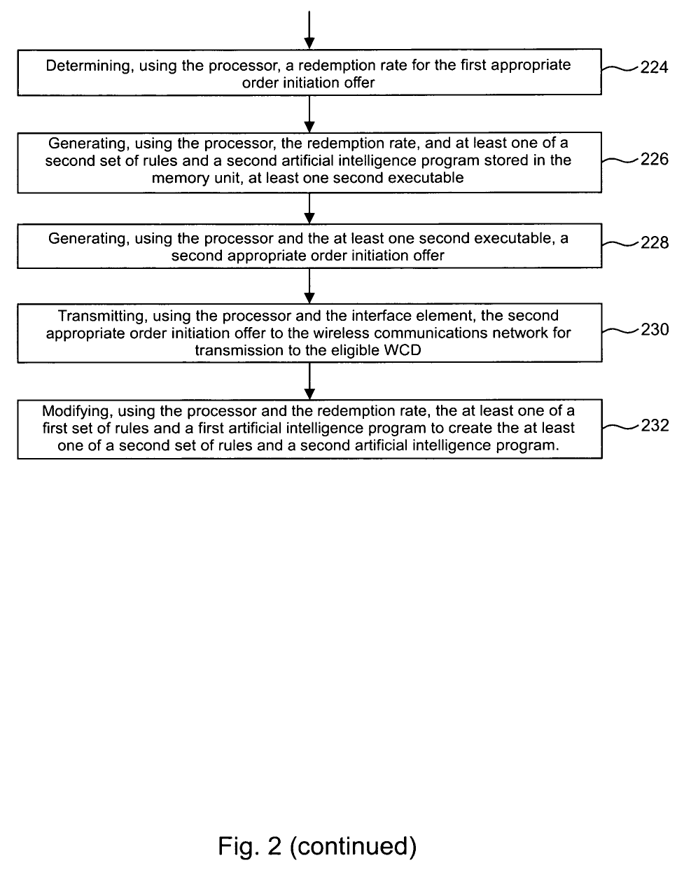

FIG. 2 is a flow chart illustrating a present invention computer-based method for generating and transmitting an order initiation offer to a wireless communications device (WCD). Although the method in FIG. 2 is depicted as a sequence of numbered steps for clarity, no order should be inferred from the numbering unless explicitly stated. The method starts at Step 200. Step 204 identifies, using a processor and an interface element in at least one specially programmed general-purpose computer, a WCD. Step 216 determines, using the processor, if the WCD is eligible to receive an order initiation offer. Step 218 generates, using the processor and at least one of a set of rules or an artificial intelligence program, at least one executable, the set of rules and the artificial intelligence program stored in a memory unit for the at least one general-purpose computer. Step 220, for an eligible WCD, generates, using the processor and the at least one executable, an appropriate order initiation offer. Step 222 transmits, using the processor and the interface element, the appropriate order initiation offer to a wireless communications network for transmission to the eligible WCD.

In a first embodiment, step 206 determines, using the processor and the interface element, a location for the WCD and determining if the WCD is eligible to receive an order initiation offer includes determining in response to the location, generating at least one executable includes generating the at least one executable responsive to the location, or generating an appropriate order initiation offer includes generating the appropriate order initiation offer responsive to the location.

In a second embodiment, step 208 accesses a transaction history, stored in the memory unit, for an end user associated with the WCD and determining if the WCD is eligible to receive an order initiation offer includes determining in response to the transaction history, and generating at least one executable includes generating the at least one executable responsive to the transaction history, or generating an appropriate order initiation offer includes generating the appropriate order initiation offer responsive to the transaction history. In one embodiment, the history includes searches made using the WCD or communications by the WCD. Alternately stated, the method links to search browsers associated with the WCD. Any type of search or WCD communication known in the art can be included in the history. For example, if the WCD has been used to search for products typically available at a retail location similar to the retail location, step 220 generates offers for transmission to the WCD when the WCD is within a specified location of such a retail location. As another example, the communications can be, but are not limited to, telephone calls or email messages to a specific retail location or to a category of retail locations. As another example, if the history shows that the WCD has communicated with the retail location, then steps 216 or 220 can be tailored in response to this information.

In a third embodiment, step 210 determines, using the processor, a transaction volume for at least one retail location and determining if the WCD is eligible to receive an order initiation offer includes determining in response to the transaction volume, and generating at least one executable includes generating the at least one executable responsive to the transaction volume, or generating an appropriate order initiation offer includes generating the appropriate order initiation offer responsive to the transaction volume.

In a fourth embodiment, step 212 determines, using the processor, whether an order has been placed previously using the WCD and determining if the WCD is eligible to receive an order initiation offer includes determining in response to whether an order has been placed previously using the WCD, and generating at least one executable includes generating the at least one executable responsive to whether an order has been placed previously using the WCD, or generating an appropriate order initiation offer includes generating the appropriate order initiation offer responsive to whether an order has been placed previously using the WCD.

In a fifth embodiment, step 214 determines, using the processor, whether an order has been placed previously using the WCD during a specified time of day or a specified day of the week and determining if the WCD is eligible to receive an order initiation offer includes determining in response to whether an order has been placed previously using the WCD during the specified time of day or the specified day of the week, and generating at least one executable includes generating the at least one executable responsive to whether an order has been placed previously using the WCD during the specified time of day or the specified day of the week, or generating an appropriate order initiation offer includes generating the appropriate order initiation offer responsive to whether an order has been placed previously using the WCD during the specified time of day or the specified day of the week.

In a sixth embodiment, step 216 obtains, using the processor, inventory information and determining if the WCD is eligible to receive an order initiation offer includes determining in response to the inventory information, and generating at least one executable includes generating the at least one executable responsive to the inventory information, or generating an appropriate order initiation offer includes generating the appropriate order initiation offer responsive to the inventory information.

In a seventh embodiment, step 224 determines, using the processor, a redemption rate for the first appropriate order initiation offer; step 226 generates, using the processor, the redemption rate, and at least one of a second set of rules and a second artificial intelligence program stored in the memory unit, at least one second executable; step 228 generates, using the processor and the at least one second executable, a second appropriate order initiation offer; and step 230 transmits, using the processor and the interface element, the second appropriate order initiation offer to the wireless communications network for transmission to the eligible WCD. In an eighth embodiment, step 232 modifies, using the processor and the redemption rate, the at least one of a first set of rules and a first artificial intelligence program to create the at least one of a second set of rules and a second artificial intelligence program.

In a ninth embodiment, determining, using the processor, if the WCD is eligible to receive an order initiation offer includes using at least one of the set of rules or the artificial intelligence program. In a tenth embodiment, determining if the WCD is eligible to receive an order initiation offer includes determining if an end user associated with the WCD is eligible for the order initiation offer. In an eleventh embodiment, determining if the WCD is eligible to receive an order initiation offer includes determining eligibility in response to the time of day, generating at least one executable includes generating the at least one executable responsive to the time of day, or generating an appropriate order initiation offer includes generating the appropriate order initiation offer responsive to the time of day. In a twelfth embodiment, determining if the WCD is eligible to receive an order initiation offer includes determining in response to a day of the week, generating at least one executable includes generating the at least one executable responsive to the day of the week, or generating an appropriate order initiation offer includes generating the appropriate order initiation offer responsive to the day of the week.

In a thirteenth embodiment, step 202 receives, using the processor and the interface element, a transmission from the WCD via the communication network and identifying a WCD includes identifying the WCD in response to the transmission.

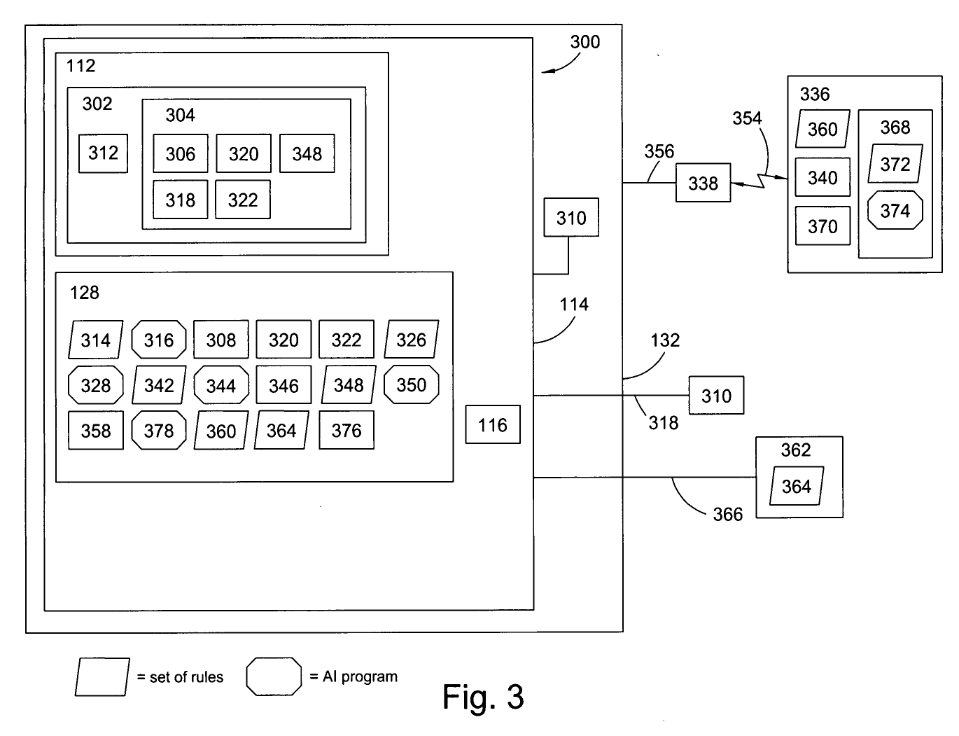

FIG. 3 is a schematic block diagram of present invention system 300 for initiating an order by scanning a coupon. Offer element 302 in processor 114: generates barcode data 304 including information 306 regarding items or services (not shown) included in fulfilled order 308 and transmits, using interface element 116, the barcode data for output at point of sale (POS) device 310. Device 310 can be inside a business location, for example, location 132, associated with operation of the system or can be located outside such business location. Any POS device known in the art can be used for device 310. In one embodiment the POS device is a wireless communications device (WCD) as disclosed by commonly-owned U.S. patent application Ser. No. 12/008,428: “SYSTEM AND METHOD FOR ENABLING POINT OF SALE FUNCTIONALITY IN A WIRELESS COMMUNICATIONS DEVICE,” inventors Otto et al., filed Jan. 11, 2008. Thus, as part of a transaction involving order 308, the barcode data is issued to the POS device handling the execution of order 308. In one embodiment, the barcode data is included in a coupon presented at the POS device. The coupon can be a paper coupon or can be an electronic coupon.

At a point after the fulfillment of order 308 and the transmission of data 304, the barcode data can be inputted to a POS device and the offer element receives, using the interface element, the barcode data inputted via the POS device. For example, a customer in possession of a coupon with the barcode data chooses to redeem the coupon by having the coupon scanned by the POS device. In one embodiment, the POS device is the same POS device outputting the barcode data. In another embodiment, the POS device is different than the POS device outputting the barcode data. The offer element generates, in response to the inputted barcode, order offer 312 including at least one item or service (not shown) included in order 308, and the offer element transmits, using the interface element, offer 312 for output via the POS device receiving the barcode data. Alternately stated, element 302 and any other elements described as being in the processor are functions of the processor or are functions carried out by the processor.

In one embodiment, offer 312 includes all the items or services included in order 308. In another embodiment, not all of the items or services in order 308 are include in the offer. In a further embodiment, the offer element adds to offer 312 at least one item or service (not shown) not included order 308; or adds to offer 312 at least one incentive not included in order 308. Any incentive known in the art can be included in offer 312, as further described infra. In one embodiment, the offer element uses one of both of set of rules 314 or artificial intelligence program 316 stored in memory unit 128 to select at least one item or service (not shown) not included in order 308 or at least one incentive not included in order 308; and, includes, in offer 312, the at least one item or service not included in the fulfilled order or the at least one incentive not included in the fulfilled order. In another embodiment, the offer element uses one of both of set of rules 314 or artificial intelligence program 316 to select one or more item, service, or incentive, included in order 308, to exclude from offer 312 and generates the offer to exclude the one or more item, service, or incentive included in order 308. Examples of criteria for the selecting operations noted above are provided infra.

In one embodiment, the barcode data includes information 318 regarding order payment authorization and the offer element executes payment for the order using the order payment authorization. In another embodiment, the barcode data includes order payment authorization 320. In a further embodiment, order payment authorization 320 is stored in the memory unit and information 318 includes information for accessing the order payment authorization in the memory unit.

In one embodiment, the offer element selects one or more conditions 322 to be associated with the generation or transmission of the offer and includes information regarding the conditions in the bar code data. These conditions are described infra and include, but are not limited to: a specified time after the barcode data is transmitted, a specific date, a specific time of day, a specific day of the week or month, or a date having a specified relationship with one or more other dates, for example, a date falling between two specified dates. In another embodiment conditions 322 are stored in the memory unit. In general, conditions 322 limit the circumstances controlling the redemption of offer 312.

At a moment in time after the transmission of data 304, the barcode data can be inputted to a POS device and the offer element receives, using the interface element, the barcode data inputted via the POS device. For example, a customer in possession of a coupon with the barcode data chooses to redeem the coupon by having the coupon scanned by the POS device. The offer element determines if the moment in time matches the condition and transmits the offer only if the moment in time matches the condition. For example, if the condition is a time interval between 2 PM and 5 PM on a week day, the offer element determines if the moment in time at which the barcode data is scanned matches the time interval. If so, the offer is transmitted. In one embodiment, the offer is generated only if the moment in time matches the condition. In another embodiment, the offer element selects condition 322 using one or both of set of rules 326 or artificial intelligence program 328 stored in the memory unit.

In one embodiment, the offer element receives at a first time, using the interface element, order 308, for fulfillment, from WCD 336 via wireless communications network 338. A WCD is defined and described supra. After fulfilling order 308, the offer element stores order 308 in the memory. Thus, receipt and fulfillment of order 308 precedes the storing of order 308 as described supra. At a later time, the offer element receives, using the interface element, input 340 from the WCD via the wireless communications network and generates, in response to receiving the input from the WCD, offer 312 to include an item or service (not shown) included in order 308. This embodiment provides an alternative to initiating the generation and transmission or offer 312. For example, input from the WCD, rather than input of barcode data through a POS, is used to initiate generation and transmission. In another embodiment, the WCD is equipped with a scanner used to scan the barcode data. In a further embodiment, the offer element selects the item or service using one or both of set of rules 342 or artificial intelligence program 344 stored in the memory unit.

In one embodiment, the offer element can receive at a first time, using the interface element, order 308 for fulfillment. The offer element also stores customer identification 346 associated with the order for fulfillment in the memory unit and, after fulfilling order 308, the offer element stores order 308 in the memory. Thus, receipt and fulfillment of order 308 precede the storing of order 308 as described supra. At a second time, the offer element can receive, using the interface element, input 348 and compares the customer identification with the input. If the identification and input match, the offer element generates offer 312 to include an item or service included in order 308. Thus the offer element analyzes the input to determine if the input includes data matching the customer identification. This embodiment provides an alternative to initiating the generation and transmission or offer 312. For example, a more general input from the WCD, rather than input of barcode data through a POS, is used to initiate generation and transmission.

WCD 336 is connected to wireless communications network 338 with radio frequency connection 354. Network 320 is connected to computer 114 with hardwire connection 356. The discussion, in the description of FIG. 1, of WCD 118 and network 130 is applicable to WCD 336 and network 338, respectively. Device(s) 336 can be any number or type of WCD known in the art.

In one embodiment, the memory unit stores transaction history 358 for the WCD, end user(s) of the WCD, or customers associated with order 308. The history tracks individual customer buying habits and/or tracks customer responses, including accept rates or use of coupons and other suggestive selling or marketing offers. In one embodiment, the offer element identifies, using the interface element, the WCD or customer using any means known in the art, for example, by identifying a WCD used by the customer to transmit order 308 or by information obtained via the POS, such as a loyalty card. The offer element selects the transaction history and generates offer 312 using the transaction history, for example, identifying trends or preferences from the history that may be useful in generating a more acceptable offer 312. The discussion supra regarding element 142 and history 144 is applicable to the offer element and history 358. In a further embodiment, the offer element analyzes the history or generates offer 312 in response to the analysis using one or both of set of rules 348 or artificial intelligence program 350 stored in the memory unit.

In one embodiment, the offer element reviews the history to identify an item or service not included in the history (and presumably never ordered by the customer) or ordered by the customer at less than a predetermined frequency. Then, the offer element includes, in offer 312, the item or service not included in the history or ordered by the customer at less than a predetermined frequency. In one embodiment, the offer element identifies the item or service using one or both of set of rules 348 or artificial intelligence program 350.

In one embodiment, computer 114 receives at least one modifying rule 360 from a WCD, for example, WCD 336, and stores the rule in memory 128. In another embodiment (not shown), the WCD transmitting rule 360 is other than WCD 336. Element 302 modifies offer 312 using rule 360. The WCD generates rule 360 and element 302 modifies offer 312 as described in commonly-owned U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 362 transmits at least one modifying rule 364 to computer 114. Computer 114 stores modifying rule 364 in memory 128. Element 302 modifies offer 312 using rule 364. Computer 362 generates rule 364, and element 302 modifies offer 312 as described in commonly-owned U.S. patent application Ser. No. 12/151,043, filed May 2, 2008 and entitled “Method and System For Centralized Generation of a Business Executable Using Genetic Algorithms and Rules Distributed Among Multiple Hardware Devices.” In another embodiment (not shown), multiple computers 362 are included and respective computers among the multiple computers can be associated with the same or different business entities. Computer 362 is connected to computer 114 by any means known in the art, for example, hardwire connection 366.

In one embodiment, a WCD, for example, WCD 336, includes memory element 368 and processor 370. In another embodiment (not shown), the WCD with the processor is other than WCD 336. WCD 336 stores at least one rule 372 in the memory element and processor 370 executes offer 312 according to rule 372. The discussion, in the description of FIG. 1, of WCD 118 and rule 184 is applicable to WCD 336 and rule 372, respectively. For example, the WCD generates rule 372, and operates on offer 312 as described in commonly-owned U.S. patent application Ser. No. 12/151,043, filed May 2, 2008 and entitled “Method and System For Centralized Generation of a Business Executable Using Genetic Algorithms and Rules Distributed Among Multiple Hardware Devices.” In one embodiment, artificial intelligence program 374 is stored in memory 368 and WCD 336 executes offer 312 using program 374. In another embodiment, WCD 366 executes offer 312 using program 374 and rule 372.

In one embodiment, offer element 302 stores information 376 in the memory element regarding the historical acceptance of offers 312. That is, information 376 is a history of the acceptance of offers 312 made in the past. The offer element then modifies rules in the memory element, for example, rules 314, 326, or 342 according to information 376. In another embodiment, the offer element uses one or more of programs 316, 328, or 344 to modify the rules. In a further embodiment, the offer element uses artificial intelligence program 378, stored in the memory element, to modify the rules. For example, the offer element can increase the frequency, in offer 312, of items, services, or incentives that have higher acceptance rates according to information 376 and can link items, services, and incentives to other parameters, such as time of day, that have affected the acceptance of the items, services, or incentives according to information 376. Such learning/modification can make use of any or all customer or other information as it becomes available or as it is stored or accumulated over time with each successive transaction.

In a further embodiment, based upon the acceptance or rejection rates by a customer or customers of offers, such as offer 312, the system determines that a particular offer is either desirable or undesirable. If found to be undesirable, e.g., due to a higher than average rejection rate, or based upon any other financial or statistical means, e.g., profit margins, gaming, dilution, fishing, diversion, speed of service, customer frequency, customer satisfaction survey or other results, e.g., via a voice survey, inventory control, corporate objectives, average check, average item counts, market basket analysis, labor rates, or any other measure or combination of the foregoing, system 300 can cease to offer such orders to the same or similar customers or to all customers.

The discussion in commonly-owned U.S. patent application Ser. No. 11/983,679, filed Nov. 9, 2006 and entitled “Method and System for Generating, Selecting, and Running Executables in a Business System Utilizing a Combination of User Defined Rules and Artificial Intelligence” regarding the modification of rules is applicable to the modification of rules 312 by the offer element.

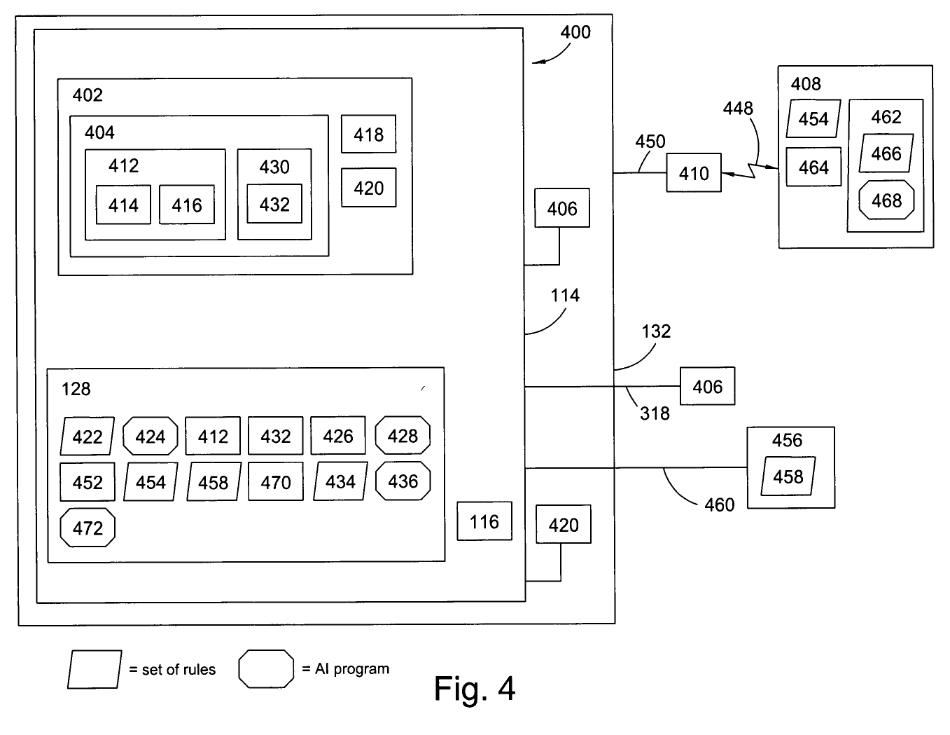

FIG. 4 is a schematic block diagram of present invention system 400 for initiating an order. Offer element 402 in processor 114 receives, at a first time and using interface element 116, order 404 from POS device 406 or from WCD 408 via wireless communications network 410. Device 406 can be inside a business location, for example, location 132, associated with operation of the system or can be located outside such business location. In one embodiment the POS device is a wireless communications device (WCD) as disclosed by commonly-owned U.S. patent application Ser. No. 12/008,428: “SYSTEM AND METHOD FOR ENABLING POINT OF SALE FUNCTIONALITY IN A WIRELESS COMMUNICATIONS DEVICE,” inventors Otto et al., filed Jan. 11, 2008.

The order includes at least one first item or service (not shown). In general, the order also includes identifying information 412. If the order is from WCD 408, the information includes identification 414 for WCD 408 or respective identifications for one or more end users of the WCD. If the order is from device 406, information 412 includes customer identification 416 associated with order 404. Customer identification is discussed supra and infra. Information 412 is stored in memory unit 128.

At a later time, the offer element can receive, using the interface element, input 418 from a WCD or a POS device 420. The input includes information identifying the WCD or an end user or users of the WCD, or a potential customer using POS device 420, respectively. In one embodiment (not shown), devices 406 and 420 are the same device. The offer element compares input 418 with identification 414 or identification 416 and matches the input with identification 414 or identification 416 as applicable. For example, if the identification for the WCD transmitting input 418 matches identification 414, the offer element identifies the WCD as WCD 408 or as a WCD associated with an end user or end users of WCD 408. In like manner, if the identification associated with the POS device transmitting input 418 matches identification 416, the offer associates input 418 with order 404.

The offer element generates offer 420 including at least one item or service included in order 404 and transmits the offer, using the interface element, for output at WCD 408 or for output at POS device 420. In one embodiment, the offer element adds to the offer at least one item or service (not shown) not included in order 404. In another embodiment, the offer element adds to the offer at least one incentive (not shown) not included in order 404. Any incentive known in the art can be included in offer 420, as further described infra. In one embodiment, the offer element selects the at least one item or service not included in order 404 using one or both of set of rules 422 or artificial intelligence program 424 stored in the memory unit. In another embodiment, the offer element selects the at least one incentive not included in order 404 using one or both of set of rules 426 or artificial intelligence program 428 stored in the memory unit. In a further embodiment, rules 422 and 426 are the same or programs 424 and 428 are the same.

In one embodiment, order 404 includes information 430 regarding order payment authorization and the offer element executes payment for an order placed in response to offer 420 using the order payment authorization. In another embodiment, information 430 includes order payment authorization 432. In a further embodiment, order payment authorization 432 is stored in the memory unit and information 430 includes information for accessing the order payment authorization in the memory unit.

Any POS device known in the art can be used for devices 406 and 420. In one embodiment, one or both of devices 406 or 420 is a wireless communications device (WCD) as disclosed by commonly-owned U.S. patent application Ser. No. 12/008,428: “SYSTEM AND METHOD FOR ENABLING POINT OF SALE FUNCTIONALITY IN A WIRELESS COMMUNICATIONS DEVICE,” inventors Otto et al., filed Jan. 11, 2008.

WCD 408 is connected to wireless communications network 410 with radio frequency connection 448. Network 410 is connected to computer 114 with hardwire connection 350. The discussion, in the description of FIG. 1, of WCD 118 and network 130 is applicable to WCD 408 and network 446, respectively. Device(s) 408 can be any number or type of WCD known in the art.

In one embodiment, the memory unit stores transaction history 452 for the WCD, end user(s) of the WCD, or customers associated with order 404. The history tracks individual customer buying habits and/or tracks customer responses, including, accept rates or use of coupons and other suggestive selling or marketing offers. In one embodiment, the offer element identifies, using the interface element, the WCD or customer using any means known in the art, for example, by identifying a WCD used by the customer to transmit order 404 or by information obtained via the POS, such as a loyalty card. The offer element selects the transaction history and generates offer 420 using the transaction history, for example, identifying trends or preferences from the history that may be useful in generating a more acceptable offer 420. The discussion supra regarding element 142 and history 144 is applicable to the offer element and history 452. In a further embodiment, the offer element analyzes the history or generates offer 420 in response to the analysis using one or both of set of rules 434 or artificial intelligence program 436 stored in the memory unit.

In one embodiment, the offer element reviews the history to identify an item or service not included in the history (and presumably never ordered by the customer) or ordered by the customer at less than a predetermined frequency. Then, the offer element includes, in offer 420, the item or service not included in the history or ordered by the customer at less than a predetermined frequency. In another embodiment, the offer element identifies the item or service using one or both of set of rules 434 or artificial intelligence program 436.

In one embodiment, computer 114 receives at least one modifying rule 454 from a WCD, for example, WCD 408, and stores the rule in memory 128. In another embodiment (not shown), the WCD transmitting rule 454 is other than WCD 408. Element 402 modifies offer 420 using rule 454. The WCD generates rule 454 and element 402 modifies offer 420 as described in commonly-owned U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 456 transmits at least one modifying rule 458 to computer 114. Computer 114 stores modifying rule 458 in memory 128. Element 402 modifies offer 420 using rule 458. Computer 456 generates rule 458, and element 402 modifies offer 420 as described in commonly-owned U.S. patent application Ser. No. 12/151,043, filed May 2, 2008 and entitled “Method and System For Centralized Generation of a Business Executable Using Genetic Algorithms and Rules Distributed Among Multiple Hardware Devices.” In another embodiment (not shown), multiple computers 456 are included and respective computers among the multiple computers can be associated with the same or different business entities. Computer 456 is connected to computer 114 by any means known in the art, for example, hardwire connection 460.

In one embodiment, a WCD, for example, WCD 408, includes memory element 462 and processor 464. In another embodiment (not shown), the WCD with the processor is other than WCD 408. WCD 408 stores at least one rule 466 in the memory element and processor 408 executes offer 420 according to rule 466. The discussion, in the description of FIG. 1, of WCD 118 and rule 184 is applicable to WCD 408 and rule 466, respectively. For example, the WCD generates rule 466, and operates on offer 420 as described in commonly-owned U.S. patent application Ser. No. 12/151,043, filed May 2, 2008 and entitled “Method and System For Centralized Generation of a Business Executable Using Genetic Algorithms and Rules Distributed Among Multiple Hardware Devices.” In one embodiment, artificial intelligence program 468 is stored in memory 462 and WCD 408 executes offer 420 using program 468. In another embodiment, WCD 408 executes offer 420 using program 468 and rule 466.

In one embodiment, offer element 402 stores information 470 in the memory element regarding the historical acceptance of offers 420. That is, information 470 is a history of the acceptance of offers 420 made in the past. The offer element then modifies rules in the memory element, for example, rules 422, 426, or 434, according to information 470. In another embodiment, the offer element uses one or more of programs 424, 428, or 436 to modify the rules. In a further embodiment, the offer element uses artificial intelligence program 472, stored in the memory element, to modify the rules. For example, the offer element can increase the frequency, in offer 420, of items, services, or incentives that have higher acceptance rates according to information 470 and can link items, services, and incentives to other parameters, such as time of day, that have affected the acceptance of the items, services, or incentives according to information 470. Such learning/modification can make use of any or all customer or other information as it becomes available or as it is stored or accumulated over time with each successive transaction.

In a further embodiment, based upon the acceptance or rejection rates by a customer or customers of offers, such as offer 420, the system determines that a particular offer is either desirable or undesirable. If found to be undesirable, e.g., due to a higher than average rejection rate, or based upon any other financial or statistical means, e.g., profit margins, gaming, dilution, fishing, diversion, speed of service, customer frequency, customer satisfaction survey or other results, e.g., via a voice survey, inventory control, corporate objectives, average check, average item counts, market basket analysis, labor rates, or any other measure or combination of the foregoing, system 400 can cease to offer such orders to the same or similar customers or to all customers.

The discussion in commonly-owned U.S. patent application Ser. No. 11/983,679, filed Nov. 9, 2006 and entitled “Method and System for Generating, Selecting, and Running Executables in a Business System Utilizing a Combination of User Defined Rules and Artificial Intelligence” regarding the modification of rules is applicable to the modification of rules by the offer element.

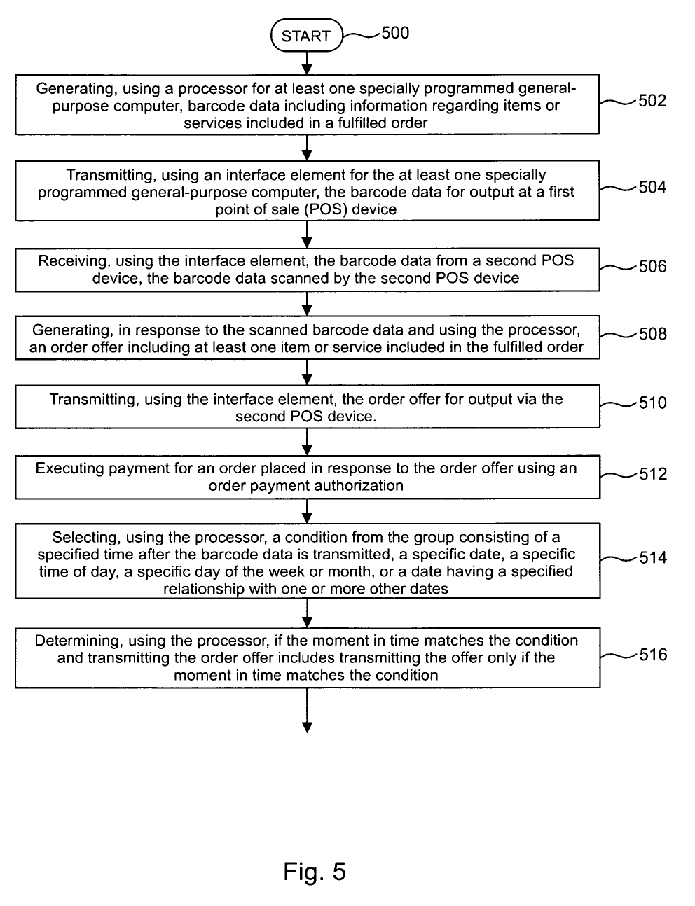

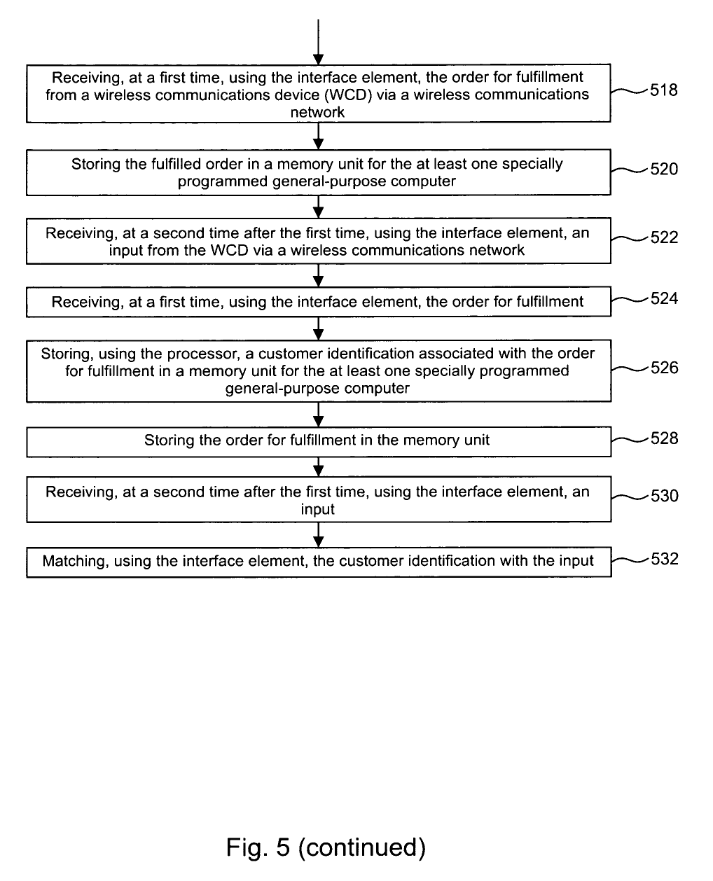

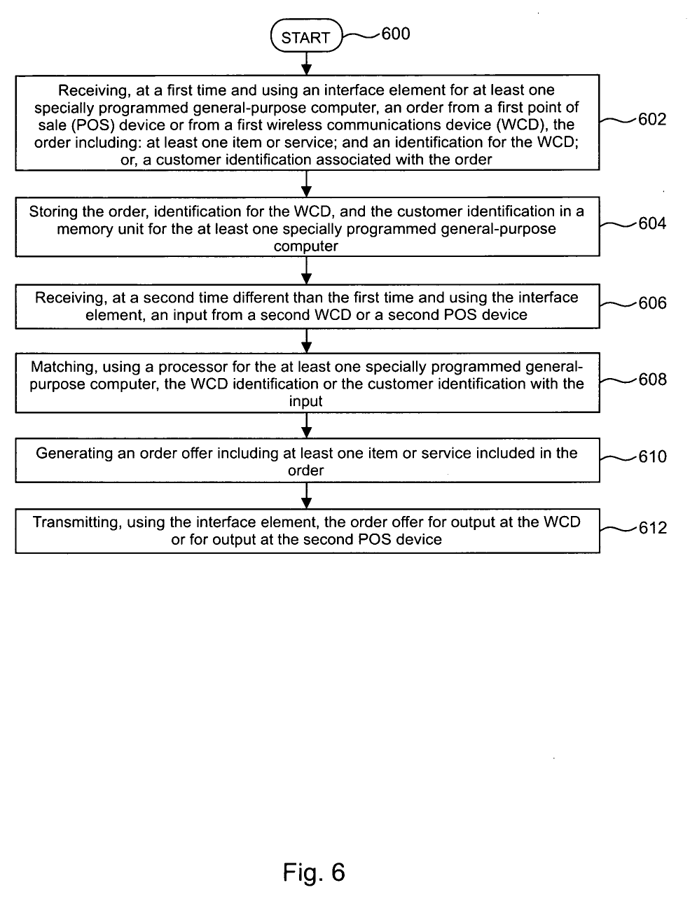

FIG. 5 is a flow chart illustrating a present invention computer-based method for initiating an order by scanning a coupon. Although the method in FIG. 5 (and FIG. 6 below) is depicted as a sequence of numbered steps for clarity, no order should be inferred from the numbering unless explicitly stated. The method starts at Step 500. Step 502 generates, using a processor for at least one specially programmed general-purpose computer, barcode data including information regarding items or services included in a fulfilled order; step 504 transmits, using an interface element for the at least one specially programmed general-purpose computer, the barcode data for output at a first point of sale (POS) device; step 506 receives, using the interface element, the barcode data from a second POS device, the barcode data scanned by the second POS device; step 508 generates, in response to the scanned barcode data and using the processor, an order offer including at least one item or service included in the fulfilled order; step 510 transmits, using the interface element, the order offer for output via the second POS device.

In one embodiment, the order offer includes all the items or services included in the fulfilled order. In another embodiment, generating the order offer includes: adding to the order offer at least one item or service not included in the fulfilled order; or adding to the order offer at least one incentive not included in the fulfilled order. In a further embodiment, generating the order offer includes: using at least one of a set of rules or an artificial intelligence program stored in a memory unit for the at least one specially programmed general-purpose computer to selecting at least one item or service not included in the fulfilled order or at least one incentive not included in the fulfilled order; and, including, in the order offer, the at least one item or service not included in the fulfilled order or the at least one incentive not included in the fulfilled order. In yet another embodiment, the barcode data includes information regarding order payment authorization and step 512 executes payment for an order placed in response to the order offer using the order payment authorization. In one embodiment, the barcode data includes the order payment authorization, or the order payment authorization is stored in a memory unit for the at least one specially programmed general-purpose computer and the barcode data includes information for accessing the order payment authorization in the memory unit.

In one embodiment, step 514 selects, using the processor, a condition from the group consisting of a specified time after the barcode data is transmitted, a specific date, a specific time of day, a specific day of the week or month, or a date having a specified relationship with one or more other dates. Generating the barcode data includes including the condition in the barcode data. The bar code data is scanned by the second POS at a moment in time. Step 516 determines, using the processor, if the moment in time matches the condition and transmitting the order offer includes transmitting the offer only if the moment in time matches the condition. In another embodiment, selecting the condition includes using at least one of a set of rules or an artificial intelligence program stored in a memory unit for the at least one specially programmed general-purpose computer.

In one embodiment, step 518 receives at a first time, using the interface element, the order for fulfillment from a wireless communications device (WCD) via a wireless communications network; step 520 stores the fulfilled order in a memory unit for the at least one specially programmed general-purpose computer; and step 522 receives at a second time after the first time, using the interface element, an input from the WCD via a wireless communications network. Generating the order offer includes generating, in response to receiving the input from the WCD, the order offer to include an item or service included in the fulfilled order. In another embodiment, generating the order offer includes: selecting, using at least one of a set of rules or an artificial intelligence program stored in the memory unit, an item or service not included in the fulfilled order; and, including, in the order offer, the item or service not included in the fulfilled order.

In one embodiment, step 524 receives at a first time, using the interface element, the order for fulfillment; step 526 stores, using the processor, a customer identification associated with the order for fulfillment in a memory unit for the at least one specially programmed general-purpose computer; step 528 stores the order for fulfillment in the memory unit; step 530 receives at a second time after the first time, using the interface element, an input; and step 532 matches, using the interface element, the customer identification with the input. Generating the order offer includes generating, in response to matching the input, the order offer to include an item or service included in the order for fulfillment. In another embodiment, generating the order offer includes: selecting, using at least one of a set of rules or an artificial intelligence program stored in the memory unit, an item or service not included in the order for fulfillment; and, including, in the order offer, the item or service not included in the order for fulfillment.

FIG. 6 is a flow chart illustrating a present invention computer-based method for initiating an order by scanning a coupon. Step 602 receives, at a first time and using an interface element for at least one specially programmed general-purpose computer, an order from a first point of sale (POS) device or from a first wireless communications device (WCD), the order including: at least one first item or service; and an identification for the WCD; or, a customer identification associated with the order; step 604 stores the order, identification for the WCD, and the customer identification in a memory unit for the at least one specially programmed general-purpose computer; step 606 receives, at a second time different than the first time and using the interface element, an input from a second WCD or a second POS device; step 608 matches, using a processor for the at least one specially programmed general-purpose computer, the WCD identification or the customer identification with the input; step 610 generates an order offer including at least one item or service included in the first order; and step 612 transmits, using the interface element, the order offer for output at the WCD or for output at the second POS device.

In one embodiment, generating the offer includes: adding to the offer at least one item or service not included in the order; or adding to the offer at least one incentive not included in the order. In another embodiment, generating the offer includes: using at least one of a set of rules or an artificial intelligence program stored in the memory unit to select at least one item or service not included in the order or at least one incentive not included in the order; and, including, in the offer, the at least one item or service not included in the order or the at least one incentive not included in the order. In a further embodiment, the offer includes all the items or services included in the order, the offer includes at least one item or service not included in the order, or the offer includes at least one incentive not included in the order.

The following should be viewed in light of FIGS. 3 through 6. The present invention provides a method and a system for automatically initiating an ordering process by accepting barcode data, for example, imbedded in a coupon, or accepting an input from a WCD or POS device. Although personnel at a business location, for example, a cashier at a quick serve restaurant can be involved in the initiating, for example, for accepting a coupon from a customer and scanning the coupon at a POS station; advantageously, the present invention also enables initiating the order process without the involvement of personnel at a business location. For example, a customer can scan a coupon at a self-serve kiosk, or using a WCD, can transmit a message using a WCD, which can be used to identify the WCD or end user(s), or can identify themselves by swiping a loyalty card at a self-service kiosk. Thus, costs associated with initiating an order can be advantageously reduced.

The following are exemplary and non-limiting possible sequences for operation of a present invention system or method:

1. Initiate previous order (auto set up previous order): receive a barcode; generate/retrieve previous order from barcode; initiate new order that is based on (i.e. identical or similar to) previous order; process payment; and output order for assembly.

2. Initiate order and add incentive (add an incentive, for example, a discounted item, to initiate transaction): receive a barcode; generate an item from the barcode with a price; initiate order; and add item with price to order.

3. Initiate offer to create previous order (barcode prompts cashier and customer if they want to load previous order): receive a barcode; generate previous order based on barcode; output offer to make current order identical to previous order; receive offer acceptance; and generate new order that is identical to previous order.

4. Initiate offer to create previous order from cell phone identification: Receive a cell phone identification; determine if identification has a previous or favorite order; output offer to ring up favorite order; if offer is accepted, and create new order with favorite order items.

5. Initiate order with a discounted item when a cell phone identification is identified: receive a cell phone identification; determine if identification has a discounted item; if discounted item is available, output offer to initiate transaction with discounted item; and if offer is accepted, initiate order and add item to order.

6. Apply discount to transactions initiated with a barcode scan: receive a barcode; initiate order; retrieve discount; and, apply discount to order.

In general, present invention offers, for example, offers 312 and 420, are directed to reaching one or more goals established by a business entity or optimizing one or more parameters associated with operations of the business entity. That is, generating an order offer includes making a selection of one or more choices from among two or more choices that yields the best or optimized outcome or yields. Ideal can mean optimizing or maximizing revenues, profits, item counts, average check, market basket contents, marketing offer acceptance, store visitation or other frequency measures, or improving or optimizing speed of service, inventory levels, turns, yield, waste, or enhancing or optimizing customer loyalty or use of kiosks or internet or other POS devices or self service devices, or use of off peak or other coupons and/or acceptance of Upsell or other marketing offers, or reduction or optimization of any customer or cashier or any other person's gaming, fishing, or any other undesirable action or activities or failures to act when desired, or minimizing or optimizing any dilution or diversion of sales, profits, average check, or minimizing or optimizing use of discounts and other promotions so as to maximize or optimize any of the foregoing desired actions, outcomes or other desired benefits, and/or any combination of minimizing undesired results while maximizing or optimizing any one or more of any desired results.

In addition to methods that may be disclosed herein, methods to provide the selection of an offer are disclosed in commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; commonly-owned U.S. patent application Ser. No. 12/151,043, filed May 2, 2008 and entitled “Method and System For Centralized Generation of a Business Executable Using Genetic Algorithms and Rules Distributed Among Multiple Hardware Devices;” and commonly-owned U.S. patent application Ser. No. 12/151,038, filed May 2, 2008 and entitled “Method and Apparatus for Generating and Transmitting an Order Initiation Offer to a Wireless Communications Device.”

In one embodiment, the discussion of the generation of executables as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007 is applicable to the generation of offers 312 and 420, in particular, to the selection of items, services, or incentives to be included in the offers. In another embodiment, the discussion of the generation of offer 120 is applicable to the generation of offers 312 and 420, in particular, to the selection of items, services, or incentives to be included in the offers.

It should be understood that various storage and removal operations, not explicitly described above, involving memory 128 and as known in the art, are possible with respect to the operation of systems 300 and 400. For example, outputs from and inputs to the general-purpose computer can be stored and retrieved from the memory elements and data generated by the processor can be stored in and retrieved from the memory.

It should be understood that the present invention can be operated by the same business entity operating or owning a business location using the system, or can be operated by a third party different than the business entity operating or owning the business location using the system. In one embodiment, a third party operates a present invention method or system as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

It should be understood that systems 300 and 400 can be integral with respective computer operating system for respective business location, for example, location 132 or with respective business entities operating the business locations. It also should be understood that systems 300 and 400 can be wholly or partly separate from the respective computer operating system for a respective retail location, for example, location 132, or with a respective business entity operating the business location.

It should be understood that although individual rule sets and artificial intelligence programs are discussed, the individual rule sets and AI programs can be combined into composite rules sets or artificial intelligence programs. Any combination of individual rule sets or artificial intelligence programs is included in the spirit and scope of the claimed invention. For example (not shown), programs 316 and 330 can be a single program or rules 422 and 426 can be a single set of rules.

The present invention leverages existing or future marketing systems, marketing programs, loyalty programs, sponsor programs, coupon programs, discount systems, incentive programs, or other loyalty, marketing, or other similar systems, collectively, “marketing systems” by adding programming logic to determine when or when not to make certain offers, or to provide a different or improved incentive to use certain ordering devices or payment methods, based upon, but not limited to, any one or more of:
1. One or more business, customer or sponsor objectives.
2. Location of a device used to enter a transaction or location or device that receives or displays a marketing message or offer or that is otherwise controlled or affected by one or more marketing systems, including, for example, at a point of sale (POS) Terminal, WCD, Internet Enabled Device, Cell Phone, Kiosk, Laptop or PC, or any other device, or a location, e.g., at a retail outlet, quick service restaurant, drive through, front counter, kiosk station, table, at home, on the road, passing by, walking by, driving by, walking or driving near to, entering or leaving a location, or any other device or location information available to any such marketing system(s).
3. Temporal parameters, such as, time of day, day of week, month, or year.
4. Any one or more data or variables available or accessible, including, for example, any customer, business or sponsor information, such as, membership in a loyalty or other marketing program, ordering preferences or history, current sales volumes or budgets or targets, current or planned-local, regional or national marketing programs or objectives, device preferences, for example, use of a kiosk in preference to a front counter or other device, current speed of service, quality of service or other operating data, budgets, objectives or trends, etc.

In a further embodiment, the present invention employs any one or more or any combination of the following, including, but not limited to discriminating based upon:
1. Location
2. Transaction Entry Device
3. Customer Information or objectives
4. Business Information or objectives
5. Sponsor Information or objectives
6. Marketing Program Type
7. Opt In Information
8. Offer Type
9. Payment method or terms or conditions of payment
10. Marketing Message Contents
11. Marketing Offer Objectives
12. Expected or Actual System Results or tracking data
13. System determined discounts or other incentives required to achieve desired results
14. One or more table entries provided by one or more end users, for example, a system administrator
15. One or more rules provided by one or more end users, for example, a system administrator
16. One or more genetic algorithms or other AI based rules or determination methods
17. Any other information, data, rules, system settings, or otherwise available to the marketing system or disclosed invention or the POS system or other system designed to deliver one or more marketing messages, offers, or coupons, etc.
18. Any combination or priority ranking of any two or more of the foregoing

In another embodiment, in an effort to further control or determine which offers to make or to determine which offers are generally more or less desirable, or to otherwise improve one or more aspects of the invention, the invention may access certain information from existing systems, including, for example, existing POS databases, such as customer transaction data, price lists, inventory information or other in or above store, for example, location data, including, but not limited to data in a POS, back office system, inventory system, revenue management system, loyalty or marketing program databases, labor management or scheduling systems, time clock data, production or other management systems, for example, kitchen production or manufacturing systems, advertising creation or tracking databases, including click through data, impressions information, results data, corporate or store or location financial information, including, for example, profit and loss information, inventory data, performance metrics, e.g., speed of service data, customer survey information, digital signage information or data, or any other available information or data, or system settings data.

In one embodiment, the present invention provides such incentives initially, or on an ongoing basis or only until certain objectives are achieved or certain customers or all customers are generally habituated to making use of such certain devices, locations or payment methods, after which, in certain embodiments, the invention may cease, temporarily or permanently making such offers based upon such discriminating factors, or may reduce the difference in incentives, or may only periodically provide such full discounts or reduced discounts so as to reinforce such behavior. In another embodiment, a system administrator or other end user establishes such rules or conditions.

In a further embodiment, the present invention makes such determinations using an automated means. Such automated means includes, for example, a system that periodically or generally continuously tests different marketing messages, content, offers or incentives or other methods, for example, user interfaces, or other benefits or incentives, and based upon such testing, determine which offers or incentives or other benefits yield the desired results or frequency of use of any such locations, devices or payment methods. Such automated system may periodically cease making such offers or providing the same or similar incentives or other benefits once it is determined that the desired customer behavior has been established, habituated or otherwise persists without need for such continued offers, incentives or benefits. If such system subsequently determines that the desired behavior has ceased or fallen below a desired level, such system can then reinstate such offers, incentives or benefits. When reinstating such offers, incentives or benefits, the present invention can return to previously successful levels or can provide less or greater incentives, offers or benefits, on a temporary, periodic or permanent basis. Such reinstatement may be provided for all customers, certain customers, classes of customers, or only those customers that have ceased or have generally reduced their frequency of desired behavior or use of generally more desirable devices, locations or payment methods.

In one embodiment, each location associated with the present invention establishes its own rules or learns from local customer behavior or other available information. In another embodiment, the present invention shares some or all available information or results data among any two or more or all locations or locations that fall within a given area, region, geography, type, or other factors, such as menu pricing, customer demographics, etc., and makes use of such information to improve the present invention's ability to determine which offers to make, the extent or duration of offers or incentives or other benefits. For example, when using an AI based system, such as disclosed in commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007,” one location may discover or otherwise determine that a certain type, class or other offer or incentive or benefit is particularly effective.

By sharing such information among other locations, for example, similar locations, the present invention can begin to make use of the same or similar incentives, offers or benefits in other generally similar locations or with other similar customers or classifications of customers so as to improve the performance of one or more other such locations or all locations. In this fashion, the present invention can learn which offers or incentives or benefits will more quickly or generally achieve the desired results or improve trends towards such results. Likewise, the present invention can more quickly determine which offers, incentives or benefits do not yield the desired results or determine how long such offers, incentives or benefits are required to achieve the desired results.

In a further embodiment, the present invention tests making or not making certain offers, incentives or providing certain benefits on a periodic basis within a single location or among a plurality of locations so as to determine the extent or requirement to make any such offers or to provide incentives or other benefits. For example, by testing making offers and not making offers, the present invention can determine if any such offers are required at all to drive business transactions to a kiosk or such a system can further determine the extent of any gaming, dilution, diversion or accretion. By alternating making and not making offers or by testing various levels of incentives or discounts, the disclosed system can better determine the optimal incentive, discount or benefits required, if any, to achieve the desired results, while minimizing or mitigating any undesirable effects of using or deploying such system. Such testing can be accomplished via any applicable or available means, including those previously disclosed by applicants herein and within the referenced applications, or randomly or using rules or AI based systems. By periodically testing or making changes to such offers, incentives or benefits, the present invention can continually strive to achieve the optimal mix and level of offers, discounts, marketing messages, marketing offers, benefits, loyalty or marketing program benefits or otherwise. By combining the use of one or more of a table, rules or Al based system, including, for example, as disclosed in the applications incorporated by reference herein, a more effective marketing system may be developed and deployed that achieves optimal or nearly optimal results over both the short and long term, without generally becoming static.

In one embodiment, the present invention tests customers of one or more locations using discounts or other marketing offers, while maintaining the regular prices at one or more other locations. By comparing the results data from such test and control groups of locations, the present invention can better determine which offers, discounts, etc., are accretive or provide net benefit or are subject to gaming, fishing or other fraudulent or undesirable activities. Such testing can be performed within a single unit as well, by periodically making and not making such offers to the same or similar customers or by randomly providing such offers or not making such offers. In another embodiment, the present invention makes use of a combination of such testing methodologies in order to best determine which offers yield optimal or the best results given the present invention information, parameters or any one or more customer, business, sponsor or present invention objectives. For example, the present invention tests in a single or group of stores certain new or untested offers, and, combines such test with a periodic offer, for example, toggling, between making and not making offers, which toggling, may be random, 50/50, or may be intelligently determined based upon system information, and continue such test for a period of time, for example, one month, while comparing results of such tests with a similar number of stores in a control group, and then, switch the process, for example, test within the original control group and stop making offers within the original test group. In this fashion the present invention determines the effects of turning on or off certain offers or types of offers and the effect of such offers on customers, customer buying habits, store or business results, or any other measures, including, for example, testing for dilution, diversion, accretion, gaming or fishing.

In a further embodiment, the present invention progressively encourages end users, for example, customers, to make use of technology that further improves the businesses results or better achieves one or more of the businesses' or customers' or sponsors' objectives. For example, in one embodiment, a business chooses to first encourage use of in store kiosks instead of using front counter POS terminals, then, once such behavior is well or generally established, the present invention then encourages use of a cell phone instead of the kiosk. In such fashion, customers may be encouraged to use less frequently or cease using devices, locations or payment methods that are generally undesirable, and to use more frequently or exclusively, those devices, locations or payment methods that are generally more desirable.

In one embodiment, prospective customers or other end users are notified, one or more times, that incentives regarding use of hardware devices exist or receive one or more specific marketing offers or messages or other incentives. For example, existing loyalty program members receive an email informing them that they can receive one or more incentives, for example, marketing offers, or coupons, or incentives or specialized pricing, or other group or one-to-one incentives or offers, if they make use of certain locations or devices or payment methods. For example, an existing loyalty member that customarily buys an item at several area locations for quick service restaurant chain using traditional front counter registers/cashiers, receives an offer to purchase such meals online or using a kiosk and, in exchange, receives 10% off on any such purchases. Such offer may be for a limited time or may be limited to certain devices only or both. Such notifications may be delivered to existing or prospective customers or other entities via any applicable means including, but not limited to:
1. Email message
2. Pop up window, banner ad, hyperlink or other online or website advertisement or communications.
3. Voice mail message
4. Text message
5. Cell phone or other telecommunications, for example, telemarketing
6. Printed materials, for example, coupon or marketing messages in the mail or as a tray liner, or hanging banners, or other printed advertising, including newspaper ads
7. Point of purchase (POP) materials, for example, printed POP materials, or electronic displays, for example, customer facing displays, etc.
8. Television or radio advertisements, including, for example, via tags on regular or other advertisements
9. Oral communications by cashiers or other persons
10. Via display on a POS terminal, customer display, customer receipt, printed or displayed coupon, etc.
11. Regular US or other postal services, e.g., regular mail
12. Express mail or courier, or
13. Any combination of the foregoing

In one embodiment, the present invention sends notification messages or marketing messages or offers or other incentives or benefits, using any one or more of the preceding communications methods and, in certain embodiments, tests which method(s) are generally more or less effective in generating the desired results or optimal results. Such system may test such communications or notifications using any applicable means, including table, rules or AI based determination means, or by periodic or random testing. By testing each method, the present invention can determine which methods of communication are more effective generally or by class or category of customer or based upon the type of communication or offer or incentive or other benefit. For example, by using such testing, the present invention may determine that offers to use a cell phone for order entry or other transaction processing is generally more effective when such message/offer is delivered via cell phone, text message, with a built in discount or other offer or training, while offers to use a kiosk might be more efficiently delivered via an oral message delivered by a cashier when the customer is or is about to place an order with such cashier. Such oral messages may be delivered as part of the cashier's general duties, that is, the cashier is trained to deliver such message(s) or a message might appear on such cashier's POS terminal prompting them to deliver a general message or such display might include the actual desired message.

In one embodiment, an administrator can add or change or otherwise modify the previous listing, or data, or determine the order of priority or preference of each such discrimination factors or preferences or data, including, for example, location, payment or device, ranking each in order of such preference or providing table, rules or other entries to provide or assist or to support determining which are preferred or the amount of incentive available or increased or decreased incentive, as a percentage or absolute or relative or other dollar or other calculation method to determine what offers, if any to make, at which locations, devices or payment methods or other discriminating factors, for example, customer or business preferences or customer, business, sponsor or other entity information, objectives, rules or other available information or rules or system settings. By providing or otherwise manually or automatically determining such rankings, the disclosed invention can initially or continuously evaluate potential marketing offers or messages and modify or deliver such marketing messages or offers or provide other incentives to drive a desired percentage of business or customer transactions to one or more particular devices, locations or payment methods.

In a further embodiment, a system administrator is permitted to enter or modify or delete or otherwise provide such marketing messages or notification content using an interface provided for such purposes. When establishing such messages or content, such administrator or other end user may be further permitted to designate which messages or content are to be generally used when using a particular type of communications. For example, one type of message or content may be designated for use when communicating via cell phone and another message or content for email and still other versions for each or all of the other various methods of communications. In one embodiment, the present invention tests each provided message or content with each such communications method to determine, partially or wholly, which message or content yields the best or optimal results over time or based upon any available information, including, for example, any available or otherwise accessible customer, business or sponsor information or objectives or by tracking actual activities and results or changes in behavior as expected or predicted by customers or other end users or classes or categories of uses or by device, location or payment method.

In a further embodiment, existing or prospective end users or customers receive one or more incentives, marketing messages or other benefits, which are provided by one or more third parties, including, for example, third party sponsors. For example, when a customer receives a 10% discount for using a WCD, the WCD manufacturer pays part or all of such discount for some or all such offers, on a temporary, periodic or permanent basis, so as to encourage use of their equipment or software. In another example, such an offer may be partially or fully subsidized by an unrelated third party sponsor. For example, a telecommunications company offers an existing or prospective customer a free item if such customer will go to any quick serve restaurant chain location and enter such order using a kiosk and view an advertisement for telecommunications company or fill out a survey or perform some other action or accept a subsequent or related optional or required offer, etc. In this fashion, third party advertisers, for example, sponsors, are able to achieve their marketing objectives, while the business, for example, the quick service establishment, is able to drive more business to generally more desirable locations, devices or payment methods or increase their sales, while customers benefit financially or via other incentives, which incentives may be paid in whole or in part, temporarily, periodically or permanently by such third party sponsors.

In a further embodiment, a present invention offer includes a discount. Such discounts can be associated or applied to specific items within the offer, or to the entire offer contents. In one embodiment, discounts are determined based upon rules established by management of the present invention or as established or modified from time to time by any authorized personnel, or may be initially established or modified using a learning system, e.g., a genetic algorithm, such as programs 314 or 422. In any such case, the present invention can make use of any or all available information, including, but not limited to customer information. Discounts can be designed to maximize, minimize or optimize any one or more business or customer objectives as desired or indicated. In another embodiment, the discount, if any, is presented to the customer as a percentage discount or as a cents or other amount off discount.

In one embodiment, discounts in incentives are used/tried relatively sparingly to determine the price elasticity of customers, both as a whole or by class, group, demographics, type or order contents, base order amounts, or specific customer's buying habits and acceptance/rejection information. In this fashion, the present invention can, over time, yield optimal results by learning or otherwise determining what incentives, if any, are required given the known information. For example, if customer A never orders item 1 with item 2, the present invention could include in the offer a 10% discount to combine items 1 and 2 in an order. If the customer rejects such offer, the present invention could attempt the same or similar offer upon the next customer's order entry, but this time offer a larger discount, for a 20% discount. Once the present invention determines a customer's price point, or the customer becomes habituated to ordering the item or service in the offer, the present invention can reduce or eliminate related discounts or other incentives.

In another embodiment, the present invention, having acquired data regarding customer price elasticity and other information, uses such information to determine other offers for the same or generally similar customers, e.g., other customers who purchase item 1 but do not typically purchase item 2. In a further embodiment, using such logic, the present invention determines classifications of customers and leverage use of such information by providing ideal order offers that are also optimized from the location or location management perspective/objectives.

In one embodiment, the offer includes a graphic representation of some or all of the items or services in the offer. In another embodiment, the offer display includes the original or full menu board price for an item or a discounted price for the item. Such discount might be conveyed as a percentage, e.g., 10% off, or using a dollar savings amount, e.g., $0.45 off the ideal order.

Customers can select an offer by any available means, including, for example, touching a screen with such one or more offers, touching a cell phone button, for example, touching a number that corresponds with one or more such offers, or speaking a command, e.g., if ordering via a voice recognition system.

In the event that a customer accepts a offer, the present invention can continue with order processing as usual or the present invention can proceed to the end of the current ordering cycle. Such end point may or may not include any post order suggestive selling. In most cases, there will be no further attempts at suggestive selling, in the assumption that the ideal order includes all items and satisfies all business goals or already has optimized the results for a given transaction. Exceptions to this process include offers to make or convert or otherwise record the accepted ideal meal as the customer's regular order, for example, as stored in history 370, or other offers that may not necessarily affect or relate to the current order, for example, an offer to provide an incentive to the customer to provide data regarding other potential customers, as disclosed in a commonly-owned U.S. patent application titled: “SYSTEM AND METHOD FOR PROVIDING INCENTIVES TO AN END USER FOR REFERRING ANOTHER END USER,” inventors Otto et al., filed concurrently. In general, such subsequent offers are unrelated to the current ideal order offer as a goal of the present invention is to avoid annoying such customer with too many offers or unwanted offers.

In another embodiment, the present invention provides incentives for existing end users or customers to encourage their friends, acquaintances or associative to make use of generally more desirable devices, locations or payment methods. For example, existing users of such devices, locations or payment methods, or based upon other criteria, are notified or encouraged to shift transactions to one or more such locations, devices or payment methods. Such notices can include one or more marketing offers or incentives that such a person can benefit from if they are successful in convincing one or more such friends, acquaintances or associates to sign up, opt in or otherwise make use of such devices, locations or payment methods. Such methods to determine which existing customers or end users to send such offers or incentives may be accomplished via any applicable means, including, for example, as described in commonly-owned U.S. patent application titled: “SYSTEM AND METHOD FOR PROVIDING INCENTIVES TO AN END USER FOR REFERRING ANOTHER END USER,” inventors Otto et al., filed concurrently, which application is incorporated by reference herein.

In a further embodiment, offers are sent to prospective customers having an identity previously provided by an existing customer, as described in commonly-owned U.S. patent application titled: “SYSTEM AND METHOD FOR PROVIDING INCENTIVES TO AN END USER FOR REFERRING ANOTHER END USER,” inventors Otto et al., filed concurrently, which application is incorporated by reference herein. In such cases, a customer refers a new or prospective member by providing an identification means, for example, a cell phone number. Once this information is made available, such prospective customer receives a marketing message or offer based in whole or in part upon such prospective member's location. For example, if an existing quick service restaurant chain customer provides one or more prospective customer's cell phone number, a present invention system may wait until such prospective customer is near one of the quick service restaurant chain's participating locations and then send such prospective member a message or offer, providing the identity of the referring party along with such message or offer. In addition or in the alternate, a present invention system could monitor the general or other travel habits of such referral, for example, prospective member, and then send one or more marketing offers or messages based in whole or in part on such information. For example, if the present invention determines that a prospective member more frequently passes by a particular quick service restaurant chain location, offers are sent to the prospective member to visit the particular location as this location, as it would appear to be generally more convenient for such prospective member.

Thus, the present invention provides a means to further optimize or discriminate among existing or potential members or customers in determining which offers, offer types, marketing messages, coupons, or other communications should be sent or suppressed based upon such habits, tendencies, patterns, locations, travel directions or any other data. Using the present invention, retailers, businesses, advertisers, sponsors and other third parties can use information or data to determine or to assist in determining when and to whom to make marketing offers or send marketing messages or provide discounts or other incentives. This discrimination provides a means to improve overall marketing success and aids in targeting existing or prospective customers by using or otherwise exploiting such information.

In one embodiment, offers are made within an establishment. In addition to or in the alternate, such establishment can make offers to existing or prospective customers before they enter such establishment, for example, while walking or driving by such establishment. While inside an establishment, marketing messages or offers may be delivered to existing or potential customers via any applicable means, including a WCD, for example, via cell phone, PDA or via any other means of communication such as use of electronic shelf labels, displays, TV's, speakers, lights, etc. For example, as a customer is walking by or near a given retail display, for example, an “end cap” that has items that may be of interest to such customer, the present invention sends a marketing message or offer that may a) describe the item or items available for sale, including, for example, features, benefits, competitive advantages, etc., or b) provide an offer for sale which may or may not include a discount or other financial incentives, for example, a buy one get one free promotion or a rebate offer. Both (a) and (b) would include a reference to hardware to be used to place an order in response to the offer.

In one embodiment, items, services, or incentives for an offer are determined or based upon any available information including, for example, one or more or any combination of any business objectives, or customer identification, customer information, customer objectives, or customer historic data such as buying habits, tendency to accept or reject any offers or similar offers, or based upon such acceptance with or without a discount, or the amount of or type of discount, willingness to accept specific items or classes of items, or whether or not such items are complementary to base order items, a usual, preferred, or last ordered items, general price elasticity as determined by prior ordering habits or those of similar customers, or classes of customers, or for a given store or location, or based upon the time of day, day of week, month, year, the weather, competitive information, such as information about current marketing campaigns, discounts, marketing offers, and like from one or more competitors.

In another embodiment, in order to receive or otherwise qualify to receive such targeted marketing messages or offers, end users, that is, existing or prospective customers are required to opt in to a cellular marketing program or some other loyalty program indicating their desire or providing permission for such marketing system or company to send one or more such marketing offers or messages. In this fashion, only those interested in such communications will be sent such communications.

In a further embodiment, such customers or prospective customers indicate the type of offers or the frequency of offers or the value of such offers, for example, amount or type of discount, etc., that they wish the present invention to consider before sending any one or more such offers. For example, a cell phone subscriber can opt in to a cellular marketing network, indicating a general willingness to accept offers, but then restrict the present invention from making certain offers or offer types or within certain categories, for example, such cell phone subscriber may be willing to accept discount offers from specific business entities but not from any others, or may accept from other retailers, but only when or if such other retailer's provide a discount greater than 20% off the usual price for the offered item or items. Using an interface to permit designation of such preferences, end users, for example, existing or prospective customers can provide the present invention with additional customer information that can help the present invention determine when or if such marketing offers are made and at what discount.

In another embodiment, customers identify themselves using overt actions, e.g., by swiping a card. In a further embodiment, in addition or in the alternative to providing such identification means overtly, customers identify themselves passively, including, for example, by providing a cell phone number, GPS identification number or IP address, or a license plate number. Commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; commonly-owned U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008; and commonly-owned U.S. patent application titled: “METHOD AND APPARATUS FOR GENERATING AND TRANSMITTING AN ORDER INITIATION OFFER TO A WIRELESS COMMUNICATIONS DEVICE,” inventors Otto et al., filed May 2, 2008, are applicable to customer identification. In yet another embodiment, the present invention uses such identification means to retrieve information about a customer, e.g., customer, business or sponsor information, which information is used to better or optimally determine if an offer or marketing message should be sent or otherwise provided to the customer.

In one embodiment, the present invention further determines which offers to make or to suppress based upon other performance data or results. In another embodiment, the present invention considers the impact of one or more offers on a customer's ability or proclivity to game or fish the present invention and avoids or ceases making offers or changes the type of offers generated and transmitted for a given customer or class of customers. For example, if a customer receives one offer to visit a given location at a given time, the present invention does not make another such offer if such customer accepts said offer, or the present invention does not make another such offer or other similar offer until a certain predefined or otherwise determined delay, for example, one month. This technique is employed to help ensure that offers, if or when accepted, are generally accretive and are not dilutive to existing sales and profits.

In another embodiment, marketing messages or marketing offers or incentives vary from customer to customer or from time to time, or in whole or in part are consistent regardless of the customer, or time or other information. In cases where offers vary, such offers can be determined via any applicable means and using any available information to make such determination, including, for example, any available customer, business or sponsor information or any one or more customer, business or sponsor objectives or any combination of the forgoing. Such offers or messages can be further determined or modified based upon information or needs or business objectives of one or more suppliers or competitors of such suppliers. For example, if while walking through the isles of a grocery store, a customer comes upon an “end cap” or an area designed to promote one or more items or brands, and such customer receives an offer to purchase, for example, buy two, two liter bottles of a beverage for the price of one. Such customer may accept such message or may receive an additional message, for example, buy two, two liter bottles of a competitor's beverage and get both for the price of one, plus one additional six pack of small cans of the competitor's beverage. In this fashion, product providers or producers or retailers or distributors may provide one or more incentives to purchase one or more products, which offers may or may not be influenced by or competitive with any other such offers.

In one embodiment, the present invention determines when and what types of offers to present based upon current or previous buying habits or any other available information regarding a customer. If for example, the customer is a loyal customer for item A, the present invention may not include an incentive with the offer and/or may send a different offer or message depending upon any known factors, for example, did the end user receive or act upon an offer for item B. If the end user did receive or act upon an offer for item B, in another embodiment, the present invention includes in a reminder regarding item A, blandishments to purchase item A instead of item B, or provide incentives matching or exceeding incentives in a reminder for item B, or query such loyal (or other) customer to determine what such customer would require in a reminder for item A to respond to the offer. In this fashion a competitive environment is created.

In a further embodiment, the end user of the present invention modifies the rules or method of operation so as to favor itself. For example, in the previous example, if the producer of item A were the sole end user of a present invention system, the producer may choose to not share any part or all of any such customer information or may use knowledge of any reminder regarding item B to its benefit. In another example, if a grocery chain was the sole end user of the present invention, the end user may choose to provide equal access to the present invention or favor one or more of its suppliers based upon any one or more of its business objectives, e.g., the profitability or perceived or actual quality or consistency or pricing of such one or more suppliers.

In one embodiment, offers are determined, in whole or in part, by two or more competing entities, for example, if a WCD is in the geographical area of two or more restaurants for which the WCD has received communications, the present invention determines the content of the respective reminders for the competing entities, in whole or in part, based upon any one or more or a combination of any or all of the following, including, for example, the general distance of the WCD from the restaurants, willingness of one or more owners or operators of the restaurant to pay for the generation and transmission of respective reminders, or the probability the end user of the WCD will respond favorable to a reminder, such as implementing an offer included in a communication, or based upon a transaction history for the end user or the WCD, for example, is the end user already a loyal customer of one or more of the restaurants, or any other available information regarding the restaurant (for example, a business), customer or sponsor's goals, objectives or information, which determination may be made via any applicable means, including, for example, use of a table-based, rules based or Al based system, including use of any genetic algorithms to improve performance over time.

For example, if a WCD associated with a loyal customer of restaurant A is approaching an area that contains both a restaurant A and a restaurant B, a present invention system licensed by a cell phone company, could transmit an offer regarding restaurant B. As another example, if a present invention system were exclusively licensed by restaurant A, restaurant A could choose to only send an offer regarding restaurant A or to increase the incentive included in such an offer only in the event it is determined that the WCD is about to or does enter the parking lot for restaurant B or actually enters restaurant B. In another example, if restaurants A and B were both non-exclusive licensees of the disclosed invention, each could choose to send one or more offers as applicable. Such offers can be based, in whole or in part, upon whether or not a WCD having received earlier communications from the restaurants is approaching a competitive location or if the transaction history for an end user of the WCD is known. For example, it is known by one or both such restaurants that the end user visits one of the restaurants more often than the other, in which case, reminders can be made to encourage continued loyalty and/or to switch brands.

In one embodiment, the present invention determines a location of a current or prospective customer. Such determination may be made using any applicable means, including, for example, using a method of triangulation of a given WCD, such as a cell phone or PDA device. Methods to locate, within a given distance a given cell phone or other cellular device, for example, a PDA equipped with cellular communications abilities, are well known by those of ordinary skill in the art and in the prior art. By considering a customer or prospective customer's current location or by estimating a destination or route of travel, a marketing system can better determine if such customer or prospective customer is or will be in the general vicinity of a given location, for example, a restaurant or retail outlet, or within a specific area within such an establishment. Such knowledge can be used to determine when or if to make certain offer types or what level of discount should be provided, if any.

For example, if a person with a cell phone has just passed by a quick service restaurant chain, the disclosed system could: a) determine if such cell phone owner is or is not an existing customer, b) if such person is not a customer such a system could provide such person with an offer, c) if such person is a current customer the present invention could further determine if such customer routinely visits such location anytime, at the current time, for example, comes often for lunch, but never for dinner, and other customer information may be assessed to determine what, if any offer should be made and what, if any discount should be provided to such customer. Once such information is made available to the present invention, the present invention can make better informed decisions as to the type of offers to make, if any, when, and at what discount level(s), if any.

For example, if a loyal quick service restaurant chain customer is passing by a particular restaurant during the dinner hours, and such customer regularly visits this or other restaurants for lunch, but rarely, if ever, visits this or other quick service restaurant locations for dinner, the present invention can offer a free or discounted item or meal if such customer visits now or at some future date during certain hours, for example, 5 pm to 11 pm.

In a further embodiment, marketing messages, content, offers, incentives, etc., are created or maintained centrally or in a distributed network, including, for example, locally. Such management may be accomplished via any applicable means available, including, for example, making use of existing, for example, off the shelf or customized tools that provide for such creating, management or distribution. In one embodiment, in an effort to further control or determine which offers to make or to determine which offers are generally more or less desirable, or to otherwise improve one or more aspects of the present invention, the present invention accesses certain information from existing systems, including, for example, existing point of sale (POS) databases, such as customer transaction data, price lists, inventory information or other in or above store, for example, location data, including, but not limited to data in a POS, back office system, inventory system, revenue management system, loyalty or marketing program databases, labor management or scheduling systems, time clock data, production or other management systems, for example, kitchen production or manufacturing systems, advertising creation or tracking databases, including click through data, impressions information, results data, corporate or store or location financial information, including, for example, profit and loss information, inventory data, performance metrics, for example, speed of service data, customer survey information, digital signage information or data, or any other available information or data, or system settings data.

In one embodiment, the present invention tracks individual and classes of existing or prospective customers so as to further improve results of the present invention. For example, in the event that limited transaction history information is available for an end user of a WCD receiving a communication, such as an offer, the present invention accumulates such information to determine when and how to generate and transmit reminders and what incentives, if any, to include with the reminders. The present invention can accumulate information regarding rejection and acceptance of offers and reminders, and other parameters regarding the offers and reminders such as types, incentives included, associated locations, items included, offer types, and discount levels.

In another embodiment, the present invention provides information to a potential purchaser of a product, informing him/her about any one or more customers in the area that have made a similar purchase. For example, if a prospective customer is seeking information about a particular car, the present invention provides information or a link to establish communications with other purchasers of the same or similar car or cars purchased from the same manufacturer or distributor/dealer, etc. In a further embodiment, such prior purchasers are first required to opt into such a program before any part or all of their information is supplied to such prospective customer(s). Such willingness may or may not include receipt of a fee for providing such information. Such fee may be paid upon providing the information, upon sharing of the information or upon a user of such information making a purchase, which purchase may or may not have been made based, in whole or in part, upon such information or any combination of the foregoing. In this manner, a network can be created to provide prospective buyers with access to information and opinions of previous buyers of the same or similar products, goods, or services. Such “word of mouth” networks are well known in society, but the present invention automates and facilitates such word of mouth communications among prospective and existing customers in ways not possible using manual social networks, including, for example, the hereinabove disclosed method of connecting prior buyers with prospective buyers, even in the case where such individuals or groups are unaware of each other's previous buying habits.

In one embodiment, in the event an existing customer's information is provided to a prospective buyer, such prospective buyer is requested or required to provide such existing customer with additional information concerning one or more products, goods or services of interest to such existing customer that such prospective customer may have purchased or is otherwise familiar with based upon such prospective customer's previous buying history.

In another embodiment, before sharing an existing customer's information with a prospective buyer, such prospective buyers prior buying history is provided or is analyzed, by the present invention or by the existing customer to determine if any such prospective customer's prior purchases are or may be of interest to such existing customer. In this manner, such existing customer may be permitted to determine if such prospective customer has any information of use to such existing customer before sharing any information of such existing customer with such prospective customer or before sharing such existing customer's identity.

In a further embodiment, rankings or scores are provided by users of such prior history or buying or satisfaction information so that potential future users of such information might better determine which information to use or accept or which information might be suspect. For example, if customer A purchases a car, and then provides feedback to prospective customers X, Y and Z, each of such prospective customers might rank the usefulness or accuracy of such information so that any future prospective customer might be advised as to other's perception of such customer A's ability to make or provide future purchase advice or information or feedback.

In one embodiment, the present invention improves results over time or with use of the invention. Such improvement or optimization can be accomplished via any means necessary including any of several methods well known in the art or as disclosed by applicants and incorporated herein by reference, including, for example, commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; commonly-owned U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008; and commonly-owned U.S. patent application titled: “METHOD AND APPARATUS FOR GENERATING AND TRANSMITTING AN ORDER INITIATION OFFER TO A WIRELESS COMMUNICATIONS DEVICE,” inventors Otto et al., filed May 2, 2008. For example, statistical methods can be used to determine which marketing messages, offers, incentives, content or other communications generally yield the desired or optimal or generally better results, or such results may be determined using one or more genetic algorithms, or a present invention administrator/operator can review results reports and then provide manual weighting criteria to further define or control the present invention, or a combination of these and other well known methods may be employed in any combination or in any order or priority.

The following is a listing of exemplary hardware and software that can be used in a present invention method or system. It should be understood that a present invention method or system is not limited to any or all of the hardware or software shown and that other hardware and software are included in the spirit and scope of the claimed invention.

1. Hardware: Central Controller/Store Server

2. Software: Create Virtual Coupon Program and Initiate Order with Barcode Scan Program

The following is a listing of exemplary data bases that can be used in a present invention method or system. It should be understood that a present invention method or system is not limited to any or all of the databases shown and that other databases are included in the spirit and scope of the claimed invention.

1. Customer Database: Customer Identification; Customer Transaction History; Personal Information; Device Identification 1-n; Regular Order 1-n; and Stored Items w/discounts 1-n

2. Inventory Database: Item Identification; Descriptor; QTY; and Price

3. Transaction Database: Transaction Identification; Items 1-n; Offer Identification 1-n; Offer Accepted; Accepted Offer Type; Coupon Identification 1-n; Transaction Type (i.e. end user device, walk up); Transaction Status; Alert Method (email, phone call, text message, etc); Alert Code (phone number, email address, etc.; Bar Code; and Receipt Number

4. Offer Database: Offer Identification; Item Identification 1-n; Offer Rules 1-n; and Offer Type

5. Coupon Database: Coupon Identification; Coupon Descriptor; Coupon rules and conditions; Coupon item id 1-n; Coupon discount 1-n; and Coupon item price 1-n

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A method for initiating an order by scanning a coupon, comprising:
generating, using a processor for at least one specially programmed general-purpose computer, barcode data including information regarding items or services included in a fulfilled order;
transmitting, using an interface element for the at least one specially programmed general-purpose computer, the barcode data for output at a first point of sale (POS) device;
receiving, using the interface element, the barcode data from a second POS device, the barcode data scanned by the second POS device;
generating, in response to the scanned barcode data and using the processor, an order offer including at least one item or service included in the fulfilled order; and,
transmitting, using the interface element, the order offer for output via the second POS device.

2. The method of claim 1 wherein generating the order offer includes: using at least one of a set of rules or an artificial intelligence program stored in a memory unit for the at least one specially programmed general-purpose computer to selecting at least one item or service not included in the fulfilled order or at least one incentive not included in the fulfilled order; and, including, in the order offer, the at least one item or service not included in the fulfilled order or the at least one incentive not included in the fulfilled order.

3. The method of claim 1 wherein the barcode data includes information regarding order payment authorization and the method including executing payment for an order placed in response to the order offer using the order payment authorization and wherein the barcode data includes the order payment authorization, or the order payment authorization is stored in a memory unit for the at least one specially programmed general-purpose computer and the barcode data includes information for accessing the order payment authorization in the memory unit.

4. The method of claim 1 further comprising selecting, using the processor, a condition from the group consisting of a specified time after the barcode data is transmitted, a specific date, a specific time of day, a specific day of the week or month, or a date having a specified relationship with one or more other dates, wherein generating the barcode data includes including the condition in the barcode data, wherein the bar code data is scanned by the second POS at a moment in time, the method further comprising determining, using the processor, if the moment in time matches the condition and wherein transmitting the order offer includes transmitting the offer only if the moment in time matches the condition.

5. The method of claim 4 wherein selecting the condition includes using at least one of a set of rules or an artificial intelligence program stored in a memory unit for the at least one specially programmed general-purpose computer.

6. The method of claim 1 further including:
receiving at a first time, using the interface element, the order for fulfillment from a wireless communications device (WCD) via a wireless communications network;
storing the fulfilled order in a memory unit for the at least one specially programmed general-purpose computer; and,
receiving at a second time after the first time, using the interface element, an input from the WCD via a wireless communications network, wherein generating the order offer includes generating, in response to receiving the input from the WCD, the order offer to include an item or service included in the fulfilled order.

7. The method of claim 6 wherein generating the order offer includes: selecting, using at least one of a set of rules or an artificial intelligence program stored in the memory unit, an item or service not included in the fulfilled order; and, including, in the order offer, the item or service not included in the fulfilled order.

8. The method of claim 1 further including:
receiving at a first time, using the interface element, the order for fulfillment;
storing, using the processor, a customer identification associated with the order for fulfillment in a memory unit for the at least one specially programmed general-purpose computer;
storing the order for fulfillment in the memory unit;
receiving at a second time after the first time, using the interface element, an input; and,
matching, using the interface element, the customer identification with the input, wherein generating the order offer includes generating, in response to matching the input, the order offer to include an item or service included in the order for fulfillment.

9. The method of claim 8 wherein generating the order offer includes: selecting, using at least one of a set of rules or an artificial intelligence program stored in the memory unit, an item or service not included in the order for fulfillment; and, including, in the order offer, the item or service not included in the order for fulfillment.

10. A method for initiating an order comprising:
receiving, at a first time and using an interface element for at least one specially programmed general-purpose computer, an order from a first point of sale (POS) device or from a first wireless communications device (WCD), the first order including:
at least one item or service; and,
an identification for the WCD; or,
a customer identification associated with the order;
storing the order, identification for the WCD, and the customer identification in a memory unit for the at least one specially programmed general-purpose computer;
receiving, at a second time different than the first time and using the interface element, an input from a second WCD or a second POS device;
matching, using a processor for the at least one specially programmed general-purpose computer, the WCD identification or the customer identification with the input;
generating an order offer including at least one item or service included in the order; and,
transmitting, using the interface element, the offer for output at the WCD or for output at the second POS device.

11. The method of claim 10 wherein generating the offer includes: using at least one of a set of rules or an artificial intelligence program stored in the memory unit to select at least one item or service not included in the order or at least one incentive not included in the order; and, including, in the offer, the at least one item or service not included in the order or the at least one incentive not included in the order.

12. A system for initiating an order by scanning a coupon, comprising:
a processor for at least one specially programmed general-purpose computer;
an interface element for the at least one specially programmed general-purpose computer; and,
an offer element, in the processor for:
generating barcode data including information regarding items or services included in a fulfilled order;
transmitting, using an interface element, the barcode data for output at a first point of sale (POS) device;
receiving, using the interface element, the barcode data from a second POS device, the barcode data scanned by the second POS device;
generating, in response to the scanned barcode data and using the processor, an order offer including at least one item or service included in the fulfilled order; and,
transmitting, using the interface element, the order offer for output via the second POS device.

13. The system of claim 12 wherein the offer element is for: using at least one of a set of rules or an artificial intelligence program stored in a memory unit for the at least one specially programmed general-purpose computer to selecting at least one item or service not included in the fulfilled order or at least one incentive not included in the fulfilled order; and, including, in the order offer, the at least one item or service not included in the fulfilled order or the at least one incentive not included in the fulfilled order.

14. The system of claim 12 wherein the barcode data includes information regarding order payment authorization and wherein the offer element is for executing payment for an order placed in response to the order offer using the order payment authorization and wherein the barcode data includes the order payment authorization, or the order payment authorization is stored in a memory unit for the at least one specially programmed general-purpose computer and the barcode data includes information for accessing the order payment authorization in the memory unit.

15. The system of claim 12 wherein the offer element is for:
selecting a condition from the group consisting of a specified time after the barcode data is transmitted, a specific date, a specific time of day, a specific day of the week or month, or a date having a specified relationship with one or more other dates; and,
including the condition in the barcode data;
wherein the bar code data is scanned by the second POS at a moment in time and the offer element is for:
determining if the moment in time matches the condition; and,
transmitting the offer only if the moment in time matches the condition.

16. The system of claim 15 wherein the offer element is for selecting the condition includes using at least one of a set of rules or an artificial intelligence program stored in a memory unit for the at least one specially programmed general-purpose computer.

17. The system of claim 12 wherein the offer element is for:
receiving at a first time, using the interface element, the order for fulfillment from a wireless communications device (WCD) via a wireless communications network;
storing the fulfilled order in a memory unit for the at least one specially programmed general-purpose computer;
receiving at a second time after the first time, using the interface element, an input from the WCD via a wireless communications network; and,
generating, in response to receiving the input from the WCD), the order offer to include an item or service included in the fulfilled order.

18. The system of claim 17 wherein the offer element is for selecting, using at least one of a set of rules or an artificial intelligence program stored in the memory unit, an item or service not included in the order for fulfillment; and, including, in the order offer, the item or service not included in the order for fulfillment.

19. The system of claim 12 wherein the offer element is for:
receiving at a first time, using the interface element, the order for fulfillment;
storing, using the processor, a customer identification associated with the order for fulfillment in a memory unit for the at least one specially programmed general-purpose computer;
storing the order for fulfillment in the memory unit;
receiving at a second time after the first time, using the interface element, an input;
matching, using the interface element, the customer identification with the input; and,
generating, in response to matching the input, the order offer to include an item or service included in the order for fulfillment.

20. The system of claim 19 wherein the offer element is for selecting, using at least one of a set of rules or an artificial intelligence program stored in the memory unit, an item or service not included in the order for fulfillment; and, including, in the order offer, the item or service not included in the order for fulfillment.

21. A system for initiating an order comprising:
a processor for at least one specially programmed general-purpose computer;
a memory element for the at least one specially programmed general-purpose computer;
an interface element for the at least one specially programmed general-purpose computer; and,
an offer element, in the processor for:
receiving, at a first time and using the interface element, an order from a first point of sale (POS) device or from a first wireless communications device (WCD), the first order including:
at least one item or service; and,
an identification for the WCD; or,
a customer identification associated with the order;
storing the order, identification for the WCD, and the customer identification in the memory unit;
receiving, at a second time different than the first time and using the interface element, an input from a second WCD or a second POS device;
matching, using the processor, the WCD identification or the customer identification with the transmission or the input, respectively;
generating an order offer including at least one item or service included in the order; and,
transmitting, using the interface element, the offer for output at the WCD or for output at the second POS device.

22. The system of claim 20 wherein the offer element is for: using at least one of a set of rules or an artificial intelligence program stored in the memory unit to select at least one item or service not included in the order or at least one incentive not included in the order; and, including, in the offer, the at least one item or service not included in the order or the at least one incentive not included in the order.
